(19) United States
(12) Patent Application Publication
(10) Pub. No.: US 2025/0117921 A1
(43) Pub. Date: Apr. 10, 2025

(54) ACTIVE LEARNING TO IMPROVE WAFER DEFECT CLASSIFICATION

(71) Applicant: ASML NETHERLANDS B.V., Veldhoven (NL)

(72) Inventors: Blagorodna ILIEVSKA ALCHEVA, Eindhoven (NL); Dimitra GKOROU, Eindhoven (NL); Harshil Jayantbhai LAKKAD, Eindhoven (NL); Artunç ULUCAN, Eindhoven (NL); Robin Theodorus Christiaan DE WIT, Veldhoven (NL)

(73) Assignee: ASML NETHERLANDS B.V., Veldhoven (NL)

(21) Appl. No.: 18/832,094

(22) PCT Filed: Jan. 19, 2023
(86) PCT No.: PCT/EP2023/051231

§ 371 Date: Jul. 22, 2024

(30) Foreign Application Priority Data
Feb. 11, 2022 (EP) 22156456.0

(51) Int. Cl. G06T 7/00; G06V 10/764

(52) U.S. Cl. CPC G06T 7/0006; G06V 10/764; G06T 2207/30148

(57) ABSTRACT

Systems and methods for training a machine learning model to classify defects with utility-function-based active learning are described. In one embodiment, one or more non-transitory, machine-readable mediums are configured to cause a processor to at least determine a utility function value for unclassified measurement images, based on a machine learning model, wherein the machine learning model is trained using a pool of labeled measurement images. Based on a determination that the utility function value for a given unclassified measurement image is less than a threshold value, the unclassified measurement image is output for classification without the use of the machine learning model. The unclassified measurement images classified via the classification without the use of the machine learning model are added to the pool of labeled measurement images. The machine learning model is trained based on the measurement images classified via the classification without the use of the machine learning model.

### CROSS-REFERENCE TO RELATED APPLICATIONS

This application claims priority of EP application 22156456.0 which was filed on 11 Feb. 2022 and which is incorporated herein in its entirety by reference.

### TECHNICAL FIELD

The present disclosure relates generally to wafer defect classification.

### BACKGROUND

In manufacturing processes of integrated circuits (ICs), unfinished or finished circuit components are inspected to ensure that they are manufactured according to design and are free of defects. Inspection systems utilizing optical microscopes or charged particle (e.g., electron) beam microscopes, such as a scanning electron microscope (SEM) can be employed. As the physical sizes of IC components continue to shrink, and their structures continue to become more complex, accuracy and throughput in defect detection and inspection become more important. The overall image quality depends on a combination of high secondary-electron and backscattered-electron signal detection efficiencies, among others. Backscattered electrons have higher emission energy to escape from deeper layers of a sample, and therefore, their detection may be desirable for imaging of complex structures such as buried layers, nodes, high-aspect-ratio trenches or holes of 3D NAND devices. For applications such as overlay metrology, it may be desirable to obtain high quality imaging and efficient collection of surface information from secondary electrons and buried layer information from backscattered electrons, simultaneously, highlighting a need for using multiple electron detectors in a SEM. Although multiple electron detectors in various structural arrangements may be used to maximize collection and detection efficiencies of secondary and backscattered electrons individually, the combined detection efficiencies remain low, and therefore, the image quality achieved may be inadequate for high accuracy and high throughput defect inspection and metrology of two-dimensional and three-dimensional structures.

In the context of semiconductor manufacture, wafer defects need to be monitored and identified. Various solutions for handling defects have been proposed.

### SUMMARY

In one embodiment, one or more non-transitory, machine-readable medium is configured to cause a processor to determine a utility function value for unclassified measurement images, based on a machine learning model, wherein the machine learning model is trained using a pool of labeled measurement images. Based on a determination that the utility function value for a given unclassified measurement image is less than a threshold value, the unclassified measurement image is output for classification without the use of the machine learning model. The unclassified measurement images classified via the classification without the use of the machine learning model are added to the pool of labeled measurement images.

In a further embodiment, wherein the determining of utility function value comprises instruction to classify the unclassified measurement images with the machine learning model and determining the utility function value based on the machine learning model.

In a further embodiment, wherein the utility function is based on uncertainty sampling.

In a further embodiment, wherein instruction to determine the utility function value comprise instructions to determine the utility function value comprise instruction to determine the utility function value based on training data corresponding to the machine learning model.

In a further embodiment, wherein the utility function value is based on representative sampling.

In a further embodiment, where the utility function value is based on class representation.

In a further embodiment, wherein the determining of the utility function value comprises instruction to classify the unclassified measurement images with the machine learning model, wherein the machine learning model classification further comprises a classification probability, and determine the utility function value based on uncertainty sampling based on classification probability and based on representative sampling based on a relationship between training data corresponding to the machine learning model and the unclassified measurement images.

In a further embodiment, wherein classification without the machine learning model comprises auxiliary classification.

In a further embodiment, further comprising instruction to evaluate the machine learning model, wherein evaluating the machine learning model comprises instructions to classify test measurement images via the machine learning model, wherein the test measurement images also have known classifications, and determine a model performance based on a relationship between the known classifications of the test measurement images and the classifications of the test measurement images classified via the machine learning model.

In a further embodiment, further comprising instruction to, based on a determination that a model performance is less than a performance threshold, iteratively train the machine learning model.

In a further embodiment, further comprising instruction to estimate a confidence value for the trained machine learning model based on evaluation measurement images, determine if a stopping criterion is satisfied based on the confidence value, and based on a determination that the stopping criterion is not satisfied, iteratively update the machine learning model based on additions to the pool of labeled measurement images.

In one embodiment, one or more non-transitory, machine-readable medium is configured to cause a processor to obtain a measurement image and use a machine learning model to classify the measurement image, where the machine learning model has been trained using a pool of labeled measurement images. The pool of labeled measurement images comprises measurement images labeled by determining a utility function value for a set of unclassified measurement images based on the machine learning model, based on a determination that the utility function value for a given unclassified measurement image is less than a threshold value, outputting the unclassified measurement image for classification without the machine learning model, and adding the unclassified measurement images classified via the classification without the use of the machine learning model to the pool of labeled measurement images.

In one embodiment, one or more non-transitory, machine-readable medium is configured to cause a processor to determine a utility function value for an unclassified measurement image based on a trained machine learning model or on uncertainty sampling, representative sampling, or a combination thereof.

In one embodiment, a system comprising a processor and one or more non-transitory, machine-readable medium to perform any of the described embodiments.

Other advantages of the embodiments of the present disclosure will become apparent from the following description taken in conjunction with the accompanying drawings wherein are set forth, by way of illustration and example, certain embodiments of the present invention.

### BRIEF DESCRIPTION OF THE DRAWINGS

The accompanying drawings, which are incorporated in and constitute a part of the specification, illustrate one or more embodiments and, together with the description, explain these embodiments. Embodiments of the invention will now be described, by way of example only, with reference to the accompanying schematic drawings in which corresponding reference symbols indicate corresponding parts, and in which:

FIG. 1 is a schematic diagram illustrating an exemplary electron beam inspection (EBI) system, consistent with embodiments of the present disclosure.

FIG. 2 is a schematic diagram illustrating an exemplary electron beam tool that can be a part of the exemplary electron beam inspection system of FIG. 1, consistent with embodiments of the present disclosure.

FIG. 3 is a schematic diagram of an exemplary charged-particle beam apparatus comprising a charged-particle detector, consistent with embodiments of the present disclosure.

FIG. 4 depicts a schematic overview of a defect detection process, according to an embodiment.

FIG. 5 depicts a schematic overview of a method of training a machine learning model to classify defect images with utility-function-based active learning, according to an embodiment.

FIG. 6 depicts a visualization of selection of defect images for active learning based on a utility function using representative sampling, according to an embodiment.

FIG. 7 depicts a visualization of selection of defect images for active learning based on a utility function using decision-node-based sampling, according to an embodiment.

FIG. 8 depicts a visualization of a selection of defect images for active learning based on a utility function using uncertainty sampling, according to an embodiment.

FIGS. 9A-9B are charts depicting example learning speeds for machine learning with various types of utility functions, according to one or more embodiment.

FIG. 10 illustrates an exemplary method for applying a utility function to an unlabeled image, according to an embodiment.

FIG. 11 illustrates an exemplary method for training a machine learning model with active learning for a utility function based on machine learning classification, according to an embodiment.

FIG. 12 illustrates an exemplary method for training a machine learning model with active learning for a utility function based on training data, according to an embodiment.

FIG. 13 illustrates an exemplary method for iteratively training a machine learning model with utility-function-based active learning, according to an embodiment.

FIG. 14 illustrates an exemplary method for determining if a training criterion is satisfied, according to an embodiment.

FIG. 15 is a block diagram of an example computer system, according to an embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations. Instead, they are merely examples of apparatuses and methods consistent with aspects related to the disclosed embodiments as recited in the appended claims. For example, although some embodiments are described in the context of utilizing electron beams, the disclosure is not so limited. Other types of charged particle beams may be similarly applied. Furthermore, other imaging systems may be used, such as optical imaging, photo detection, x-ray detection, etc.

Electronic devices are constructed of circuits formed on a piece of silicon called a substrate. Many circuits may be formed together on the same piece of silicon and are called integrated circuits or ICs. The size of these circuits has decreased dramatically so that many more of them can fit on the substrate. For example, an IC chip in a smart phone can be as small as a thumbnail and yet may include over 2 billion transistors, the size of each transistor being less than 1/1000th the size of a human hair.

Making these extremely small ICs is a complex, time-consuming, and expensive process, often involving hundreds of individual steps. Errors in even one step have the potential to result in defects in the finished IC, thereby rendering it useless. Thus, one goal of the manufacturing process is to avoid such defects to maximize the number of functional ICs made in the process, that is, to improve the overall yield of the process.

One component of improving yield is monitoring the chip making process to ensure that it is producing a sufficient number of functional integrated circuits. One way to monitor the process is to inspect the chip circuit structures at various stages of their formation. Inspection can be carried out using a scanning electron microscope (SEM). An SEM can be used to image these extremely small structures, in effect, taking a “picture” of the structures. The image can be used to determine if the structure was formed properly and also if it was formed in the proper location. If the structure is defective, then the process can be adjusted so the defect is less likely to recur. It may be desirable to have higher throughput for defect detection and inspection processes to meet the requirements of IC manufacturers.

As used herein, the term “diffraction” refers to the behavior of a beam of light or other electromagnetic radiation when encountering an aperture or series of apertures, including a periodic structure or grating. “Diffraction” can include both constructive and destructive interference, including scattering effects and interferometry. As used herein, a “grating” is a periodic structure, which can be one-dimensional (i.e., comprised of posts of dots), two-dimensional, or three-dimensional, and which causes optical interference, scattering, or diffraction. A “grating” can be a diffraction grating.

As used herein, the term “backside” refers to a side of the wafer which has minimal fabrication steps performed upon it, while the term “frontside” refers to a side of the wafer with a majority of fabrication steps performed upon it. The backside can comprise a side of a wafer which is contacted by wafer handling devices and/or wafer chucks. The backside can undergo processing, such as through wafer via construction, backside metallization, oxidation, wafer dicing, etc. The frontside can experience the majority of lithography, alignment, etch, implantation, etc. type steps.

As used herein, a “backside defect” refers to a defect detected on a backside of a wafer. Backside defects can be classified into multiple classes or categories, where some example categories include damage, droplet, particle, nuisance, etc. Backside defect classes may not be equally represented. Backside defects can be detected in one or more metrology step, including surface profilometry, optical imaging, SEM imaging, etc. A set of backside defect images may include unequally represented classifications or categories. For example, particle defects can comprise 70% of a set of defect images, while particle-induced imprint defects can comprise 1% of defects. As backside defects correspond to fabrication processing steps and metrics, identification of rare defects can be more important than identification of common defects. Traditional machine learning models can neglect rare defects due to model-bias.

As used herein, a “frontside defect” refers to a defect detected on the frontside of a wafer. Frontside defects can be classified into multiple classes or categories, including based on their cause, appearance, deleterious effect on fabricated semiconductor devices, location, etc. Some example categories include over etch, under etch, misalignment, particle, incomplete exposure, over exposure, incomplete liftoff, particle, etc. Frontside defects can be localized to a specific area and/or can occur at multiple locations over a wafer surface. Frontside defects can be detected in one or more metrology steps, including profilometry, optical imaging, SEM imaging, etc. Frontside defect detection can involve non-invasive metrology, such as optical metrology, or can involve destructive metrology, such as cross-sectional SEM imaging. Frontside defects may not be equally represented and may not be equally detected. For example, particle defects can be buried by a depositional layer and may not be detected via optical metrology. These particle defects may be detected by cross-sectional SEM imaging and/or electrical testing, but as cross-sectional SEM imaging is a destructive metrology technique it may not be a frontline or routine analysis procedure which can make buried particles less likely to be detected.

As used herein, “active learning” is a method of machine learning or algorithm training where a machine learning algorithm interacts with an information source (which can be an operator, teacher, oracle, etc. which may be a human or a piece of software, another algorithm, and/or machine learning model) to obtain labels for one or more piece of unlabeled piece of data. The information source can be queried by the machine learning algorithm training or other software, such for each piece of unlabeled data. The information source can also label or otherwise act on a set or batch of unlabeled data. Unlabeled data can be fed or otherwise output to the information source, or the information source can request or obtain the unlabeled data, such as from a pool of unlabeled data. Active learning can include iterative training or updating of a machine learning model or algorithm, such as based on one or more batches of data labeled by the information source or a total set of data labeled by the information source. Data labeled by the information source can comprise a pool of labeled data. Active learning can be adaptive, responding to changes in the unlabeled data or the pool of unlabeled data. Active learning can be a method of incremental learning or training. Unlabeled data can comprise unclassified data, where a classification can comprise a labeled and/or data can be labeled with a classification.

As used herein, a “utility function” is a function (for example as may be operated or determined by software, hardware, or other systems including operated in conjunction with a user or controller) which outputs one or more values which correspond to utility of a given piece of data. The data can be an image, including a defect image (e.g., a backside defect image and/or a frontside defect image). The data can be labeled data, such as a defect image classified by a machine learning classifier, or can be unlabeled data. The utility function can output a single value, such as an integer or fraction. The utility function can also output a vector or multi-dimensional value, such as a vector with components corresponding to multiple measures of utility. The utility function value can fall within one or more ranges, such as between zero and one, between negative one and positive one, etc., or be one or more percentage or probability or confidence value. The utility function value corresponds to the utility (or usefulness) of the piece of data as training data for a machine learning model, such as for active learning.

The utility function of a piece of data can have a high value when the machine learning model, as previously trained, can classify the given piece of data to a high degree of certainty, such as with a high classification probability or with a large confidence interval. High probability and low probability may be relative, and may depend on the model and the general classification probability and confidence of data classification in the field. For example, a classification probability of 0.9 (i.e., corresponding to a 90% likelihood of a specific classification) can be considered a low probability for a well-trained model is a robust field, which a classification probability of 0.5 may be considered a high probability for a model in early-stage training in a new field. The utility function can also have a high value when the piece of data is similar to other pieces of data in a training set previously used to train the machine learning model. For example, a duplicate of an image already included in the training set may be expected to have the highest possible utility value (or the range of utility values) as its classification is known based on the duplicate image (from the training set) which is labeled with a known classification. The utility function of a piece of data can have a low value when the machine learning model cannot classify the given piece of data to a high degree of certainty or with a high probability and/or has not been trained on a similar piece of data or class of data.

Utility function values can depend on multiple methods of determinations of the utility of a piece of data (for example, a defect image). Utility function values for a single piece of data can include both high value components and low value components. For example, a defect image may have a high utility function value corresponding to a high probability (i.e., the current iteration of the machine learning model could classify the defect image with high confidence and therefore have a high utility value based on a high classification probability, but if the defect image belongs to a class which is underrepresented in the training data it could also have a low utility function value based on class representation). A total utility value can be determined based on multiple utility value components, which can include normalization of one or more utility function value components.

Herein, one or more high utility value for a defect image corresponds to a defect image which is expected to be well-classified by the current iteration of the machine learning model and one or more low utility value for a defect image corresponds to a defect image which is not expected to be well-classified by the current iteration of the machine learning model. This should not be taken as limiting, as a high utility value can instead correspond to a defect image which is not expected to be well-classified by the current iteration of the machine learning model and one or more low utility values for a defect image can instead correspond to a defect image which is expected to be well-classified by the current iteration of the machine learning model. The magnitude of the utility function value can depend on the structure of the utility value function, which can be arbitrary.

A method of wafer defect classification based on active learning is described. According to embodiments of the present disclosure, identification and/or classification of a defect image, can be improved by using active learning to train a machine learning model for defect classification. In active learning, unlabeled training data or images are fed to an auxiliary classifier to produce a set of training data, where the auxiliary classifier can be a user, an expert, or other resource intensive classification method of system. Active learning can further comprise active learning based on a utility function, where the utility function can be used to select images for classification by the auxiliary classification method. By selecting images based on the utility function for auxiliary classification, training of the machine learning model can be improved in speed, accuracy, and/or other performance metrics, which can lead to a reduction in training cost as generating training data can be expensive (both monetarily and/or temporally). Additionally, for class imbalance in training data can lead to undertraining or misidentification of sparsely represented classifications. By using a utility function to account for representation or class imbalance, classification of rare classes can be improved. Utility-function-based active learning can be used to improve speed, accuracy, precision, and other performance metrics of defect classification.

The utility function can be used to select training data or additional training data based on a trained machine learning model and/or training data previously used to train a machine learning model. The machine learning model can then be iteratively trained based on the previous training data and additional selected training data. Training of the machine learning model can be iteratively updated, or a new trained machine learning model can be generated based on the updated set of training data. According to embodiments of the present disclosure, the utility function can determine utility of training data, which can be additional training data or images, based on uncertainty. Uncertainty sampling can be used to determine the uncertainty or classification probability of one or more images or other data by using a trained machine learning model. The machine learning model can then be iteratively trained on batches of auxiliary classified data, where the data for auxiliary classification is selected based on the utility function. According to embodiments of the present disclosure, the utility function can determine utility of training data or images for auxiliary classification based on representativeness. Representative sampling can be used to determine the representativeness of one or more image or other data as compared to the set of training data previously used to train the model. Additionally, the utility function can determine utility based on decision boundary sampling, various types of uncertainty sampling, various types of representative sampling, distribution sampling, class representation, etc.

Training the machine learning model can further comprise determining if a training criterion is satisfied, such that training can be concluded. The training criterion can comprise a testing criterion, based on a set of test data with known classifications. The training criterion can comprise a stopping criterion, based on a set of stopping data without known classifications. The stopping criterion can comprise a confidence criterion, such that the stopping criterion is met when further training reduces the confidence of the trained model on the set of stopping data—i.e., where the stopping criterion can be related to overtraining.

Training the machine learning model can further comprise deploying the trained machine learning model and/or classifying on or more image based on the trained model. The image or defect image can comprise an image of a back side defect. The defect image can comprise an SEM image, an optical image, etc.

Relative dimensions of components in drawings may be exaggerated for clarity. Within the following description of drawings, the same or like reference numbers refer to the same or like components or entities, and only the differences with respect to the individual embodiments are described. As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

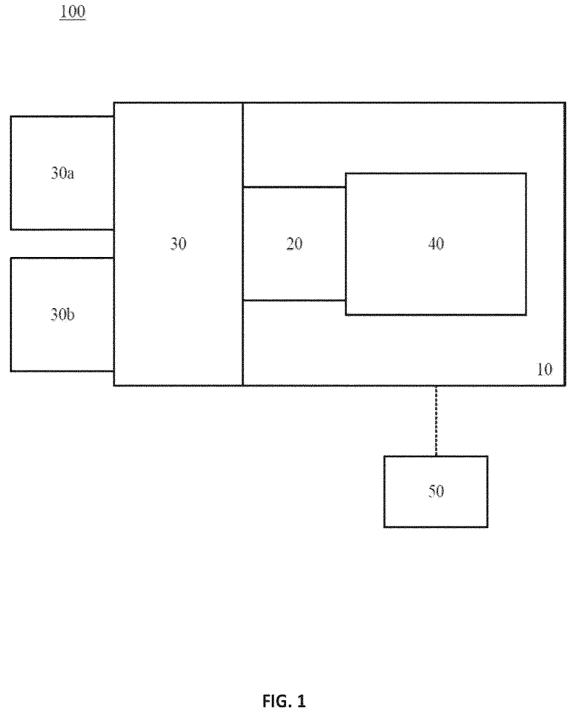

Reference is now made to FIG. 1, which illustrates an exemplary electron beam inspection (EBI) system 100 consistent with embodiments of the present disclosure. As shown in FIG. 1, charged particle beam inspection system 100 includes a main chamber 10, a load-lock chamber 20, an electron beam tool 40, and an equipment front end module (EFEM) 30. Electron beam tool 40 is located within main chamber 10. While the description and drawings are directed to an electron beam, it is appreciated that the embodiments are not used to limit the present disclosure to specific charged particles.

EFEM 30 includes a first loading port 30a and a second loading port 30b. EFEM 30 may include additional loading port(s). First loading port 30a and second loading port 30b receive wafer front opening unified pods (FOUPs) that contain wafers (e.g., semiconductor wafers or wafers made of other material(s)) or samples to be inspected (wafers and samples are collectively referred to as “wafers” hereafter). One or more robot arms (not shown) in EFEM 30 transport the wafers to load-lock chamber 20.

Load-lock chamber 20 is connected to a load/lock vacuum pump system (not shown), which removes gas molecules in load-lock chamber 20 to reach a first pressure below the atmospheric pressure. After reaching the first pressure, one or more robot arms (not shown) transport the wafer from load-lock chamber 20 to main chamber 10. Main chamber 10 is connected to a main chamber vacuum pump system (not shown), which removes gas molecules in main chamber 10 to reach a second pressure below the first pressure. After reaching the second pressure, the wafer is subject to inspection by electron beam tool 40. In some embodiments, electron beam tool 40 may comprise a single-beam inspection tool.

Controller 50 may be electronically connected to electron beam tool 40 and may be electronically connected to other components as well. Controller 50 may be a computer configured to execute various controls of charged particle beam inspection system 100. Controller 50 may also include processing circuitry configured to execute various signal and image processing functions. While controller 50 is shown in FIG. 1 as being outside of the structure that includes main chamber 10, load-lock chamber 20, and EFEM 30, it is appreciated that controller 50 can be part of the structure.

While the present disclosure provides examples of main chamber 10 housing an electron beam inspection system, it should be noted that aspects of the disclosure in their broadest sense, are not limited to a chamber housing an electron beam inspection system. Rather, it is appreciated that the foregoing principles may be applied to other chambers as well, such as a chamber of a deep ultraviolet (DUV) lithography or an extreme ultraviolet (EUV) lithography system.

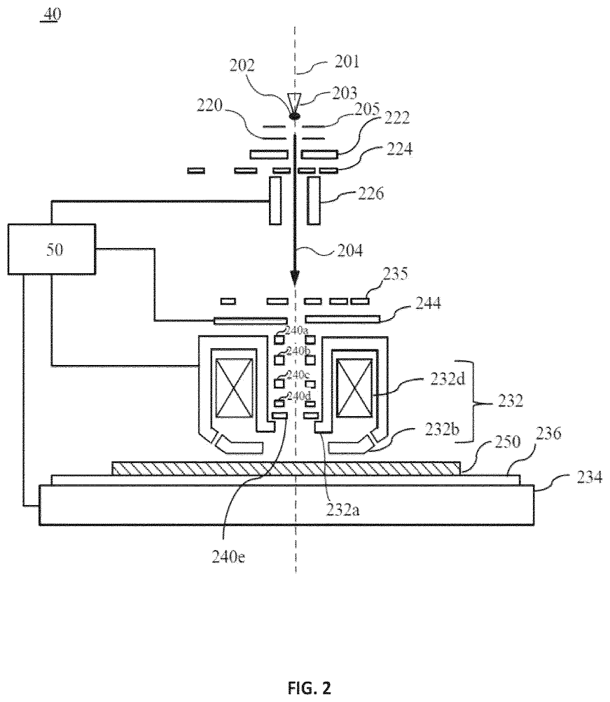

Reference is now made to FIG. 2, which illustrates a schematic diagram illustrating an exemplary configuration of electron beam tool 40 that can be a part of the exemplary charged particle beam inspection system 100 of FIG. 1, consistent with embodiments of the present disclosure. Electron beam tool 40 (also referred to herein as apparatus 40) may comprise an electron emitter, which may comprise a cathode 203, an extractor electrode 205, a gun aperture 220, and an anode 222. Electron beam tool 40 may further include a Coulomb aperture array 224, a condenser lens 226, a beam-limiting aperture array 235, an objective lens assembly 232, and an electron detector 244. Electron beam tool 40 may further include a sample holder 236 supported by motorized stage 234 to hold a sample 250 to be inspected. It is to be appreciated that other relevant components may be added or omitted, as needed.

In some embodiments, an electron emitter may include cathode 203 and anode 222, wherein primary electrons can be emitted from the cathode and extracted or accelerated to form a primary electron beam 204 that forms a primary beam crossover 202. Primary electron beam 204 can be visualized as being emitted from primary beam crossover 202.

In some embodiments, the electron emitter, condenser lens 226, objective lens assembly 232, beam-limiting aperture array 235, and electron detector 244 may be aligned with a primary optical axis 201 of apparatus 40. In some embodiments, electron detector 244 may be placed off primary optical axis 201, along a secondary optical axis (not shown).

Objective lens assembly 232, in some embodiments, may comprise a modified swing objective retarding immersion lens (SORIL), which includes a pole piece 232a, a control electrode 232b, a beam manipulator assembly comprising deflectors 240a, 240b, 240d, and 240e, and an exciting coil 232d. In a general imaging process, primary electron beam 204 emanating from the tip of cathode 203 is accelerated by an accelerating voltage applied to anode 222. A portion of primary electron beam 204 passes through gun aperture 220, and an aperture of Coulomb aperture array 224, and is focused by condenser lens 226 so as to fully or partially pass through an aperture of beam-limiting aperture array 235. The electrons passing through the aperture of beam-limiting aperture array 235 may be focused to form a probe spot on the surface of sample 250 by the modified SORIL lens and deflected to scan the surface of sample 250 by one or more deflectors of the beam manipulator assembly. Secondary electrons emanated from the sample surface may be collected by electron detector 244 to form an image of the scanned area of interest.

In objective lens assembly 232, exciting coil 232d and pole piece 232a may generate a magnetic field. A part of sample 250 being scanned by primary electron beam 204 can be immersed in the magnetic field and can be electrically charged, which, in turn, creates an electric field. The electric field may reduce the energy of impinging primary electron beam 204 near and on the surface of sample 250. Control electrode 232b, being electrically isolated from pole piece 232a, may control, for example, an electric field above and on sample 250 to reduce aberrations of objective lens assembly 232, to adjust the focusing of signal electron beams for high detection efficiency, or to avoid arcing to protect the sample. One or more deflectors of the beam manipulator assembly may deflect primary electron beam 204 to facilitate beam scanning on sample 250. For example, in a scanning process, deflectors 240a, 240b, 240d, and 240e can be controlled to deflect primary electron beam 204, onto different locations of top surface of sample 250 at different time points, to provide data for image reconstruction for different parts of sample 250. It is noted that the order of 240a-e may be different in different embodiments.

Backscattered electrons (BSEs) and secondary electrons (SEs) can be emitted from the part of sample 250 upon receiving primary electron beam 204. A beam separator 240c can direct the secondary or scattered electron beam(s), comprising backscattered and secondary electrons, to a sensor surface of electron detector 244. The detected secondary electron beams can form corresponding beam spots on the sensor surface of electron detector 244. Electron detector 244 can generate signals (e.g., voltages, currents) that represent the intensities of the received secondary electron beam spots, and provide the signals to a processing system, such as controller 50. The intensity of secondary or backscattered electron beams, and the resultant secondary electron beam spots, can vary according to the external or internal structure of sample 250. Moreover, as discussed above, primary electron beam 204 can be deflected onto different locations of the top surface of sample 250 to generate secondary or scattered electron beams (and the resultant beam spots) of different intensities. Therefore, by mapping the intensities of the secondary electron beam spots with the locations of sample 250, the processing system can reconstruct an image that reflects the internal or external structures of sample 250, which can comprise a wafer sample.

In some embodiments, controller 50 may comprise an image processing system that includes an image acquirer (not shown) and a storage (not shown). The image acquirer may comprise one or more processors. For example, the image acquirer may comprise a computer, server, mainframe host, terminals, personal computer, any kind of mobile computing devices, and the like, or a combination thereof. The image acquirer may be communicatively coupled to electron detector 244 of apparatus 40 through a medium such as an electrical conductor, optical fiber cable, portable storage media, IR, Bluetooth, internet, wireless network, wireless radio, among others, or a combination thereof. In some embodiments, the image acquirer may receive a signal from electron detector 244 and may construct an image. The image acquirer may thus acquire images of regions of sample 250. The image acquirer may also perform various post-processing functions, such as generating contours, superimposing indicators on an acquired image, and the like. The image acquirer may be configured to perform adjustments of brightness and contrast, etc. of acquired images. In some embodiments, the storage may be a storage medium such as a hard disk, flash drive, cloud storage, random access memory (RAM), other types of computer readable memory, and the like. The storage may be coupled with the image acquirer and may be used for saving scanned raw image data as original images, and post-processed images.

In some embodiments, controller 50 may include measurement circuitries (e.g., analog-to-digital converters) to obtain a distribution of the detected secondary electrons and backscattered electrons. The electron distribution data collected during a detection time window, in combination with corresponding scan path data of a primary electron beam 204 incident on the sample (e.g., a wafer) surface, can be used to reconstruct images of the wafer structures under inspection. The reconstructed images can be used to reveal various features of the internal or external structures of sample 250, and thereby can be used to reveal any defects that may exist in the wafer.

In some embodiments, controller 50 may control motorized stage 234 to move sample 250 during inspection. In some embodiments, controller 50 may enable motorized stage 234 to move sample 250 in a direction continuously at a constant speed. In other embodiments, controller 50 may enable motorized stage 234 to change the speed of the movement of sample 250 over time depending on the steps of scanning process.

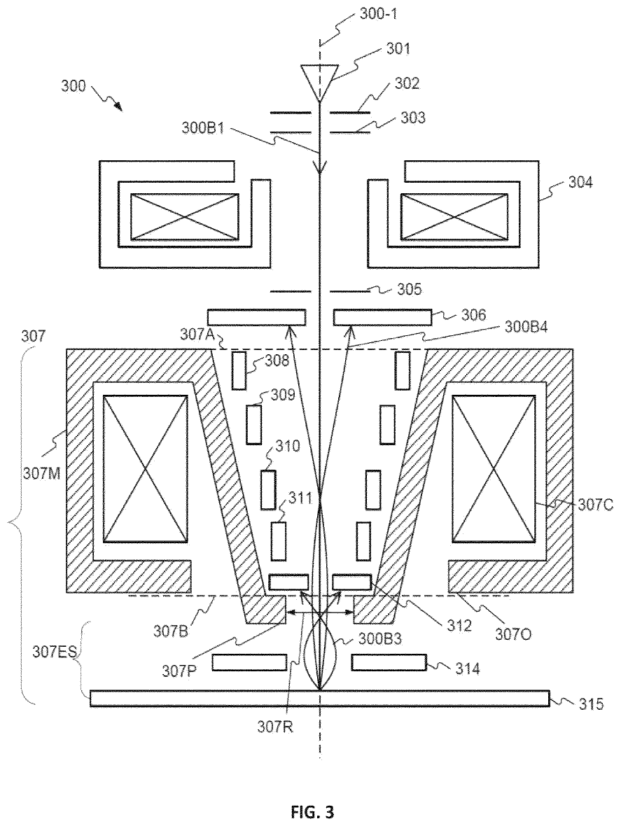

As is commonly known in the art, interaction of charged particles, such as electrons of a primary electron beam with a sample (e.g., sample 315 of FIG. 3, discussed later), may generate signal electrons containing compositional and topographical information about the probed regions of the sample. Secondary electrons (SEs) may be identified as signal electrons with low emission energies, and backscattered electrons (BSEs) may be identified as signal electrons with high emission energies. Because of their low emission energy, an objective lens assembly may direct the SEs along electron paths and focus the SEs on a detection surface of in-lens electron detector placed inside the SEM column. BSEs traveling along electron paths may be detected by the in-lens electron detector as well. In some cases, BSEs with large emission angles, however, may be detected using additional electron detectors, such as a backscattered electron detector, or remain undetected, resulting in loss of sample information needed to inspect a sample or measure critical dimensions.

Detection and inspection of some defects in semiconductor fabrication processes, such as buried particles during photolithography, metal deposition, dry etching, or wet etching, among others, may benefit from inspection of surface features as well as compositional analysis of the defect particle. In such scenarios, information obtained from secondary electron detectors and backscattered electron detectors to identify the defect(s), analyze the composition of the defect(s), and adjust process parameters based on the obtained information, among others, may be desirable for a user.

The emission of SEs and BSEs obeys Lambert's law and has a large energy spread. SEs and BSEs are generated upon interaction of primary electron beam with the sample, from different depths of the sample and have different emission energies. For example, secondary electrons originate from the surface and may have an emission energy ≤50 eV, depending on the sample material, or volume of interaction, among others. SEs are useful in providing information about surface features or surface geometries. BSEs, on the other hand, are generated by predominantly elastic scattering events of the incident electrons of the primary electron beam and typically have higher emission energies in comparison to SEs, in a range from 50 eV to approximately the landing energy of the incident electrons, and provide compositional and contrast information of the material being inspected. The number of BSEs generated may depend on factors including, but are not limited to, atomic number of the material in the sample, acceleration voltage of primary electron beam, among others.

Based on the difference in emission energy, or emission angle, among others, SEs and BSEs may be separately detected using separate electron detectors, segmented electron detectors, energy filters, and the like. For example, an in-lens electron detector may be configured as a segmented detector comprising multiple segments arranged in a two-dimensional or a three-dimensional arrangement. In some cases, the segments of in-lens electron detector may be arranged radially, circumferentially, or azimuthally around a primary optical axis (e.g., primary optical axis 300-1 of FIG. 3).

Reference is now made to FIG. 3, which illustrates a schematic diagram of an exemplary charged-particle beam apparatus 300 (also referred to as apparatus 300), consistent with embodiments of the present disclosure. Apparatus 300 can be a part of the exemplary electron beam tool of FIG. 2 and/or a part of the exemplary charge particle beam inspection system 100 of FIG. 1. Apparatus 300 may comprise a charged-particle source such as, an electron source configured to emit primary electrons from a cathode 301 and extracted using an extractor electrode 302 to form a primary electron beam 300B1 along a primary optical axis 300-1. Apparatus 300 may further comprise an anode 303, a condenser lens 304, a beam-limiting aperture array 305, signal electron detectors 306 and 312, a compound objective lens 307, a scanning deflection unit comprising primary electron beam deflectors 308, 309, 310, and 311, and a control electrode 314. In the context of this disclosure, one or both of signal electron detectors 306 and 312 may be in-lens electron detectors located inside the electron-optical column of a SEM and may be arranged rotationally symmetric around primary optical axis 300-1. In some embodiments, signal electron detector 312 may be referred to as a first electron detector, and signal electron detector 306 may be referred to as through-the-lens detector, immersion lens detector, upper detector, or second electron detector. It is to be appreciated that relevant components may be added, omitted, or reordered, as appropriate.

An electron source (not shown) may include a thermionic source configured to emit electrons upon being supplied thermal energy to overcome the work function of the source, a field emission source configured to emit electrons upon being exposed to a large electrostatic field, etc. In the case of a field emission source, the electron source may be electrically connected to a controller, such as controller 50 of FIG. 1, configured to apply and adjust a voltage signal based on a desired landing energy, sample analysis, source characteristics, among others. Extractor electrode 302 may be configured to extract or accelerate electrons emitted from a field emission gun, for example, to form primary electron beam 300B1 that forms a virtual or a real primary beam crossover (not illustrated) along primary optical axis 300-1. Primary electron beam 300B1 may be visualized as being emitted from the primary beam crossover. In some embodiments, the controller may be configured to apply and adjust a voltage signal to extractor electrode 302 to extract or accelerate electrons generated from electron source. An amplitude of the voltage signal applied to extractor electrode 302 may be different from the amplitude of the voltage signal applied to cathode 301. In some embodiments, the difference between the amplitudes of the voltage signal applied to extractor electrode 302 and to cathode 301 may be configured to accelerate the electrons downstream along primary optical axis 300-1 while maintaining the stability of the electron source. As used in the context of this disclosure, “downstream” refers to a direction along the path of primary electron beam 300B1 starting from the electron source towards sample 315. With reference to positioning of an element of a charged-particle beam apparatus (e.g., apparatus 300 of FIG. 3), “downstream” may refer to a position of an element located below or after another element, along the path of primary electron beam starting from the electron source, and “immediately downstream” refers to a position of a second element below or after a first element along the path of primary electron beam 300B1 such that there are no other active elements between the first and the second element. For example, as illustrated in FIG. 3, signal electron detector 306 may be positioned immediately downstream of beam-limiting aperture array 305 such that there are no other optical or electron-optical elements placed between beam-limiting aperture array 305 and electron detector 306. As used in the context of this disclosure, “upstream” may refer to a position of an element located above or before another element, along the path of primary electron beam starting from the electron source, and “immediately upstream” refers to a position of a second element above or before a first element along the path of primary electron beam 300B1 such that there are no other active elements between the first and the second element. As used herein, “active element” may refer to any element or component, the presence of which may modify the electromagnetic field between the first and the second element, either by generating an electric field, a magnetic field, or an electromagnetic field.

Apparatus 300 may comprise condenser lens 304 configured to receive a portion of or a substantial portion of primary electron beam 300B1 and to focus primary electron beam 300B1 on beam-limiting aperture array 305. Condenser lens 304 may be substantially similar to condenser lens 226 of FIG. 2 and may perform substantially similar functions. Although shown as a magnetic lens in FIG. 3, condenser lens 304 may be an electrostatic, a magnetic, an electromagnetic, or a compound electromagnetic lens, among others. Condenser lens 304 may be electrically coupled with a controller, such as controller 50 of FIG. 2. The controller may apply an electrical excitation signal to condenser lens 304 to adjust the focusing power of condenser lens 304 based on factors including operation mode, application, desired analysis, sample material being inspected, among others.

Apparatus 300 may further comprise beam-limiting aperture array 305 configured to limit beam current of primary electron beam 300B1 passing through one of a plurality of beam-limiting apertures of beam-limiting aperture array 305. Although only one beam-limiting aperture is illustrated in FIG. 3, beam-limiting aperture array 305 may include any number of apertures having uniform or non-uniform aperture size, cross-section, or pitch. In some embodiments, beam-limiting aperture array 305 may be disposed downstream of condenser lens 304 or immediately downstream of condenser lens 304 (as illustrated in FIG. 3) and substantially perpendicular to primary optical axis 300-1. In some embodiments, beam-limiting aperture array 305 may be configured as an electrically conducting structure comprising a plurality of beam-limiting apertures. Beam-limiting aperture array 305 may be electrically connected via a connector (not illustrated) with controller 50, which may be configured to instruct that a voltage be supplied to beam-limiting aperture array 305. The supplied voltage may be a reference voltage such as, for example, ground potential. The controller may also be configured to maintain or adjust the supplied voltage. Controller 50 may be configured to adjust the position of beam-limiting aperture array 305.

Apparatus 300 may comprise one or more signal electron detectors 306 and 312. Signal electron detectors 306 and 312 may be configured to detect substantially all secondary electrons and a portion of backscattered electrons based on the emission energy, emission polar angle, emission azimuthal angle of the backscattered electrons, among others. In some embodiments, signal electron detectors 306 and 312 may be configured to detect secondary electrons, backscattered electrons, or auger electrons. Signal electron detector 312 may be disposed downstream of signal electron detector 306. In some embodiments, signal electron detector 312 may be disposed downstream or immediately downstream of primary electron beam deflector 311. Signal electrons having low emission energy (typically ≤50 eV) or small emission polar angles, emitted from sample 315 may comprise secondary electron beam(s) 300B4, and signal electrons having high emission energy (typically >50 eV) and medium emission polar angles may comprise backscattered electron beam(s) 300B3. In some embodiments, 300B4 may comprise secondary electrons, low-energy backscattered electrons, or high-energy backscattered electrons with small emission polar angles. It is appreciated that although not illustrated, a portion of backscattered electrons may be detected by signal electron detector 306, and a portion of secondary electrons may be detected by signal electron detector 312. In overlay metrology and inspection applications, signal electron detector 306 may be useful to detect secondary electrons generated from a surface layer and backscattered electrons generated from the underlying deeper layers, such as deep trenches or high aspect-ratio holes.

Apparatus 300 may further include compound objective lens 307 configured to focus primary electron beam 300B1 on a surface of sample 315. The controller may apply an electrical excitation signal to the coils 307C of compound objective lens 307 to adjust the focusing power of compound objective lens 307 based on factors including primary beam energy, application need, desired analysis, sample material being inspected, among others. Compound objective lens 307 may be further configured to focus signal electrons, such as secondary electrons having low emission energies, or backscattered electrons having high emission energies, on a detection surface of a signal electron detector (e.g., in-lens signal electron detector 306 or detector 312). Compound objective lens 307 may be substantially similar to or perform substantially similar functions as objective lens assembly 232 of FIG. 2. In some embodiments, compound objective lens 307 may comprise an electromagnetic lens including a magnetic lens 307M, and an electrostatic lens 307ES formed by control electrode 314, polepiece 307P, and sample 315.

As used herein, a compound objective lens is an objective lens producing overlapping magnetic and electrostatic fields, both in the vicinity of the sample for focusing the primary electron beam. In this disclosure, though condenser lens 304 may also be a magnetic lens, a reference to a magnetic lens, such as 307M, refers to an objective magnetic lens, and a reference to an electrostatic lens, such as 307ES, refers to an objective electrostatic lens. As illustrated in FIG. 3, magnetic lens 307M and electrostatic lens 307ES, working in unison, for example, to focus primary electron beam 300B1 on sample 315, may form compound objective lens 307. The lens body of magnetic lens 307M and coil 307C may produce the magnetic field, while the electrostatic field may be produced by creating a potential difference, for example, between sample 315, and polepiece 307P. In some embodiments, control electrode 314 or other electrodes located between polepiece 307P and sample 315, may also be a part of electrostatic lens 307ES.

In some embodiments, magnetic lens 307M may comprise a cavity defined by the space between imaginary planes 307A and 307B. It is to be appreciated that imaginary planes 307A and 307B, marked as broken lines in FIG. 3, are visual aids for illustrative purposes only. Imaginary plane 307A, located closer to condenser lens 304, may define the upper boundary of the cavity, and imaginary plane 307B, located closer to sample 315, may define the lower boundary of the cavity of magnetic lens 307M. As used herein, the “cavity” of the magnetic lens refers to space defined by the element of the magnetic lens configured to allow passage of the primary electron beam, wherein the space is rotationally symmetric around the primary optical axis. The term “within the cavity of magnetic lens” or “inside the cavity of the magnetic lens” refers to the space bound within the imaginary planes 307A and 307B and the internal surface of the magnetic lens 307M directly exposed to the primary electron beam. Planes 307A and 307B may be substantially perpendicular to primary optical axis 300-1. Although FIG. 3 illustrates a conical cavity, the cross-section of the cavity may be cylindrical, conical, staggered cylindrical, staggered conical, or any suitable cross-section.

Apparatus 300 may further include a scanning deflection unit comprising primary electron beam deflectors 308, 309, 310, and 311, configured to dynamically deflect primary electron beam 300B1 on a surface of sample 315. In some embodiments, scanning deflection unit comprising primary electron beam deflectors 308, 309, 310, and 311 may be referred to as a beam manipulator or a beam manipulator assembly. The dynamic deflection of primary electron beam 300B1 may cause a desired area or a desired region of interest of sample 315 to be scanned, for example in a raster scan pattern, to generate SEs and BSEs for sample inspection. One or more primary electron beam deflectors 308, 309, 310, and 311 may be configured to deflect primary electron beam 300B1 in X-axis or Y-axis, or a combination of X- and Y-axes. As used herein, X-axis and Y-axis form Cartesian coordinates, and primary electron beam 300B1 propagates along Z-axis or primary optical axis 300-1.

Electrons are negatively charged particles and travel through the electron-optical column, and may do so at high energy and high speeds. One way to deflect the electrons is to pass them through an electric field or a magnetic field generated, for example, by a pair of plates held at two different potentials, or passing current through deflection coils, among other techniques. Varying the electric field or the magnetic field across a deflector (e.g., primary electron beam deflectors 308, 309, 310, and 311 of FIG. 3) may vary the deflection angle of electrons in primary electron beam 300B1 based on factors including, but are not limited to, electron energy, magnitude of the electric field applied, dimensions of deflectors, among others.

In some embodiments, one or more primary electron beam deflectors 308, 309, 310, and 311 may be located within the cavity of magnetic lens 307M. As illustrated in FIG. 3, all primary electron beam deflectors 308, 309, 310, and 311, in their entirety, may be located within the cavity of magnetic lens 307M. In some embodiments, at least one primary electron beam deflector, in its entirety, may be located within the cavity of magnetic lens 307M. In some embodiments, a substantial portion of the magnetic field generated by passing electrical current through coil 307C may be present in magnetic lens 307M such that each deflector is located inside the magnetic field lines of magnetic lens 307M or is influenced by the magnetic field of magnetic lens 307M. In such a scenario, sample 315 may be considered to be outside the magnetic field lines and may not be influenced by the magnetic field of magnetic lens 307M. A beam deflector (e.g., primary electron beam deflector 308 of FIG. 3) may be disposed circumferentially along the inner surface of magnetic lens 307M. One or more primary electron beam deflectors may be placed between signal electron detectors 306 and 312. In some embodiments, all primary electron beam deflectors may be placed between signal electron detectors 306 and 312.

As disclosed herein, a polepiece of a magnetic lens (e.g., magnetic lens 307M) is a piece of magnetic material near the magnetic poles of a magnetic lens, while a magnetic pole is the end of the magnetic material where the external magnetic field is the strongest. As illustrated in FIG. 3, apparatus 300 comprises polepieces 307P and 3070. As an example, polepiece 307P may be the piece of magnetic material near the north pole of magnetic lens 307M, and polepiece 3070 may be the piece of magnetic material near the south pole of magnetic lens 307M. When the current in magnetic lens coil 307C changes directions, then the polarity of the magnetic poles may also change. In the context of this disclosure, the positioning of electron detectors (e.g., signal electron detector 312 of FIG. 3), beam deflectors (e.g., beam deflectors 308-311 of FIG. 3), electrodes (e.g., control electrode 314 of FIG. 3) may be described with reference to the position of polepiece 307P located closest to the point where primary optical axis 300-1 intersects sample 315. Polepiece 307P of magnetic lens 307M may comprise a magnetic pole made of a soft magnetic material, such as electromagnetic iron, which concentrates the magnetic field substantially within the cavity of magnetic lens 307M. Polepieces 307P and 3070 may be high-resolution polepieces, multiuse polepieces, or high-contrast polepieces, for example.

As illustrated in FIG. 3, polepiece 307P may comprise an opening 307R configured to allow primary electron beam 300B1 to pass through and allow signal electrons to reach signal detectors 306 and 312. Opening 307R of polepiece 307P may be circular, substantially circular, or non-circular in cross-section. In some embodiments, the geometric center of opening 307R of polepiece 307P may be aligned with primary optical axis 300-1. In some embodiments, as illustrated in FIG. 3, polepiece 307P may be the furthest downstream horizontal section of magnetic lens 307M, and may be substantially parallel to a plane of sample 315. Polepieces (e.g., 307P and 307O) are one of several distinguishing features of magnetic lens over electrostatic lens. Because polepieces are magnetic components adjacent to the magnetic poles of a magnetic lens, and because electrostatic lenses do not produce a magnetic field, electrostatic lenses do not have polepieces.

One of several ways to separately detect signal electrons such as SEs and BSEs based on their emission energy includes passing the signal electrons generated from probe spots on sample 315 through an energy filtering device. In some embodiments, control electrode 314 may be configured to function as an energy filtering device and may be disposed between sample 315 and signal electron detector 312. In some embodiments, control electrode 314 may be disposed between sample 315 and magnetic lens 307M along the primary optical axis 300-1. Control electrode 314 may be biased with reference to sample 315 to form a potential barrier for the signal electrons having a threshold emission energy. For example, control electrode 314 may be biased negatively with reference to sample 315 such that a portion of the negatively charged signal electrons having energies below the threshold emission energy may be deflected back to sample 315. As a result, only signal electrons that have emission energies higher than the energy barrier formed by control electrode 314 propagate towards signal electron detector 312. It is appreciated that control electrode 314 may perform other functions as well, for example, affecting the angular distribution of detected signal electrons on signal electron detectors 306 and 312 based on a voltage applied to control electrode. In some embodiments, control electrode 314 may be electrically connected via a connector (not illustrated) with the controller (not illustrated), which may be configured to apply a voltage to control electrode 314. The controller may also be configured to apply, maintain, or adjust the applied voltage. In some embodiments, control electrode 314 may comprise one or more pairs of electrodes configured to provide more flexibility of signal control to, for example, adjust the trajectories of signal electrons emitted from sample 315.

In some embodiments, sample 315 may be disposed on a plane substantially perpendicular to primary optical axis 300-1. The position of the plane of sample 315 may be adjusted along primary optical axis 300-1 such that a distance between sample 315 and signal electron detector 312 may be adjusted. In some embodiments, sample 315 may be electrically connected via a connector with controller (not illustrated), which may be configured to supply a voltage to sample 315. The controller may also be configured to maintain or adjust the supplied voltage.

In currently existing SEMs, signals generated by detection of secondary electrons and backscattered electrons are used in combination for imaging surfaces, detecting and analyzing defects, obtaining topographical information, morphological and compositional analysis, among others. By detecting the secondary electrons and backscattered electrons, the top few layers and the layers underneath may be imaged simultaneously, thus potentially capturing underlying defects, such as buried particles, overlay errors, among others. However, overall image quality may be affected by the efficiency of detection of secondary electrons as well as backscattered electrons. While high-efficiency secondary electron detection may provide high-quality images of the surface, the overall image quality may be inadequate because of inferior backscattered electron detection efficiency. Therefore, it may be beneficial to improve backscattered electron detection efficiency to obtain high-quality imaging, while maintaining high throughput.

As illustrated in FIG. 3, apparatus 300 may comprise signal electron detector 312 located immediately upstream of polepiece 307P and within the cavity of magnetic lens 307M. Signal electron detector 312 may be placed between primary electron beam deflector 311 and polepiece 307P. In some embodiments, signal electron detector 312 may be placed within the cavity of magnetic lens 307M such that there are no primary electron beam deflectors between signal electron detector 312 and sample 315.

In some embodiments, polepiece 307P may be electrically grounded or maintained at ground potential to minimize the influence of the retarding electrostatic field associated with sample 315 on signal electron detector 312, therefore minimizing the electrical damage, such as arcing, that may be caused to signal electron detector 312. In a configuration such as shown in FIG. 3, the distance between signal electron detector 312 and sample 315 may be reduced so that the BSE detection efficiency and the image quality may be enhanced while minimizing the occurrence of electrical failure or damage to signal electron detector 312.

In some embodiments, signal electron detectors 306 and 312 may be configured to detect signal electrons having a wide range of emission polar angles and emission energies. For example, because of the proximity of signal electron detector 312 to sample 315, it may be configured to collect backscattered electrons having a wide range of emission polar angles, and signal electron detector 306 may be configured to collect or detect secondary electrons having low emission energies.

Signal electron detector 312 may comprise an opening configured to allow passage of primary electron beam 300B1 and signal electron beam 300B4. In some embodiments, the opening of signal electron detector 312 may be aligned such that a central axis of the opening may substantially coincide with primary optical axis 300-1. The opening of signal electron detector 312 may be circular, rectangular, elliptical, or any other suitable shape. In some embodiments, the size of the opening of signal electron detector 312 may be chosen, as appropriate. For example, in some embodiments, the size of the opening of signal electron detector 312 may be smaller than the opening of polepiece 307P close to sample 315. In some embodiments, where the signal electron detector 306 is a single-channel detector, the opening of signal electron detector 312 and the opening of signal electron detector 306 may be aligned with each other and with primary optical axis 300-1. In some embodiments, signal electron detector 306 may comprise a plurality of electron detectors, or one or more electron detectors having a plurality of detection channels. In embodiments where the signal electron detector 306 comprises a plurality of electron detectors, one or more detectors may be located off-axis with respect to primary optical axis 300-1. In the context of this disclosure, “off-axis” may refer to the location of an element such as a detector, for example, such that the primary axis of the element forms a non-zero angle with the primary optical axis of the primary electron beam. In some embodiments, the signal electron detector 306 may further comprise an energy filter configured to allow a portion of incoming signal electrons having a threshold energy to pass through and be detected by the electron detector.

The location of signal electron detector 312 within the cavity of magnetic lens 307M as shown in FIG. 3 may further enable easier assembly and alignment of signal electron detector 312 with other electron-optical components of apparatus 300. Electrically grounded polepiece 307P may substantially shield signal electron detector 312 from the influence of the retarding electrostatic field of electrostatic lens 307ES formed by polepiece 307P, control electrode 314, and sample 315.

One of several ways to enhance image quality and signal-to-noise ratio may include detecting more backscattered electrons emitted from the sample. The angular distribution of emission of backscattered electrons may be represented by a cosine dependence of the emission polar angle (cos(O), where θ is the emission polar angle between the backscattered electron beam and the primary optical axis). While a signal electron detector may efficiently detect backscattered electrons of medium emission polar angles, the large emission polar angle backscattered electrons may remain undetected or inadequately detected to contribute towards the overall imaging quality. Therefore, it may be desirable to add another signal electron detector to capture large angle backscattered electrons.

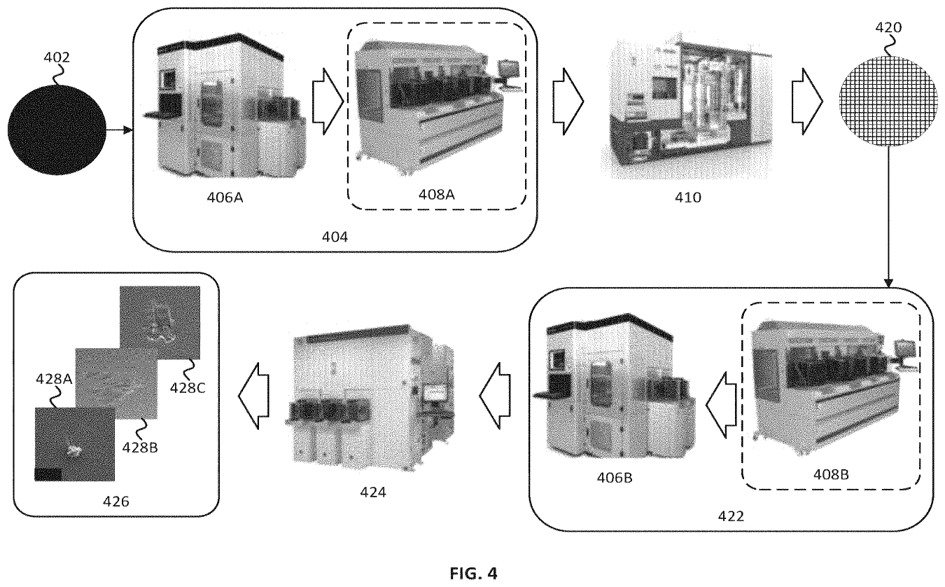

As a further introduction, FIG. 4 depicts a schematic overview of a defect detection process. Defect detection can comprise one or more steps in a wafer fabrication qualification process, and can detect damage, particles, droplets, etc. which are present on the backside of the wafer. As the wafer undergoes one or more fabrication processes (including but not limited to lithography, etch, cleaning, etc.) defects on the wafer can be incurred and accumulate. Defects can be frontside defects or backside defects. In one embodiment, defect detection is used for backside defect detection. By tracking the accumulation or presence of defects on the backside of the wafer, information about the fabrication process occurring on the front side of the wafer can be inferred. For example, particle defects on the backside of the wafer can indicate that particle defects may also be accumulating on the front side of the wafer, perhaps due to incomplete cleaning, which can cause bridging between features on the order of the particle size and other deleterious effects on both CD and performance parameters. Backside imaging can also be performed at greater frequency than frontside imaging, where scanning electron microscopy (SEM) imaging can potentially damage fabricated structures, device, materials, etc., including photoresist layers. In another embodiment, defect detection can also or instead be used for frontside defect detection. FIG. 4 depicts an unfabricated wafer 402 which is selected for an initial measurement 404. The unfabricated wafer 402 can instead start as a partially fabricated wafer, but for ease of reference starting wafers are being referred to herein as “unfabricated.” The initial measurement 404 comprises one or more measurements with a measurement device 406A which determines a baseline for defect type, density, frequency, etc. The measurement device 406A can be an electron beam inspection system (EBI), such as described in reference to FIGS. 1-3. The measurement device 406A can alternatively comprise scanning electron microscopy (SEM) apparatus in any appropriate configuration. The measurement device 406A can, alternatively or additionally, comprise an optical inspection system. The initial measurement 404 can be a measurement performed on the backside of the wafer or the frontside of the wafer. If the measurement 404 is a measurement of the backside of the wafer, the unfabricated wafer 402 is then optionally processed by a sorter and/or flipper 408A, which presents the frontside of the wafer for processing. The unfabricated wafer 402 undergoes one or more processing steps in one or more scanner and/or lithographic device 410 to produce a fabricated wafer 420. The fabricated wafer 420 can also be a partially fabricated wafer after one or more fabrication steps, with remaining steps to be performed, but for ease of reference the “fabricated” wafer refers to herein a wafer that has gone through at least some (or additional) fabrication steps after being in the form of what is referred to herein as an “unfabricated” wafer. The fabricated wafer 420 is then selected for a post-processing measurement 422. If the post-processing measurement 422 is a measurement of the backside of the wafer, the post-processing measurement 422 comprises optional processing by a sorter and/or flipper 408B, which can be the same or different processing as performed by the sorter and/or flipper 408A (the flipper flipping the wafer between front side and backside). The post-processing measurement 422 includes one or more measurements with a measurement device 406B, which can be the same or different as the measurement with the measurement device 406A. The post-processing measurement 422 is used to locate and measure one or more defect. One or more of the defects can be selected, by an operator, machine learning model, etc., for further measurement. In some embodiments, the defects are images, and then one or more of the defect images are selected for output for classification. The one or more selected defects are imaged by a scanning electron microscopy (SEM) device 424. The SEM device 424 can be an electron beam inspection system (EBI), such as described in reference to FIGS. 1-3. The SEM device 424 can alternatively comprise scanning electron microscopy (SEM) apparatus in any appropriate configuration. The SEM device 424 can additionally comprise an optical inspection system. Alternatively, the selected defects can be imaged by an optical imaging device. The SEM device 424 is used, by an operator, controller, or imaging program, to produce a set of unlabeled defect images 426, which can include defect images 428A-428C. The defect images can then be output for classification, where classification of the defect images can be used for fabrication process control, including determination of key performance indicators (KPIs).

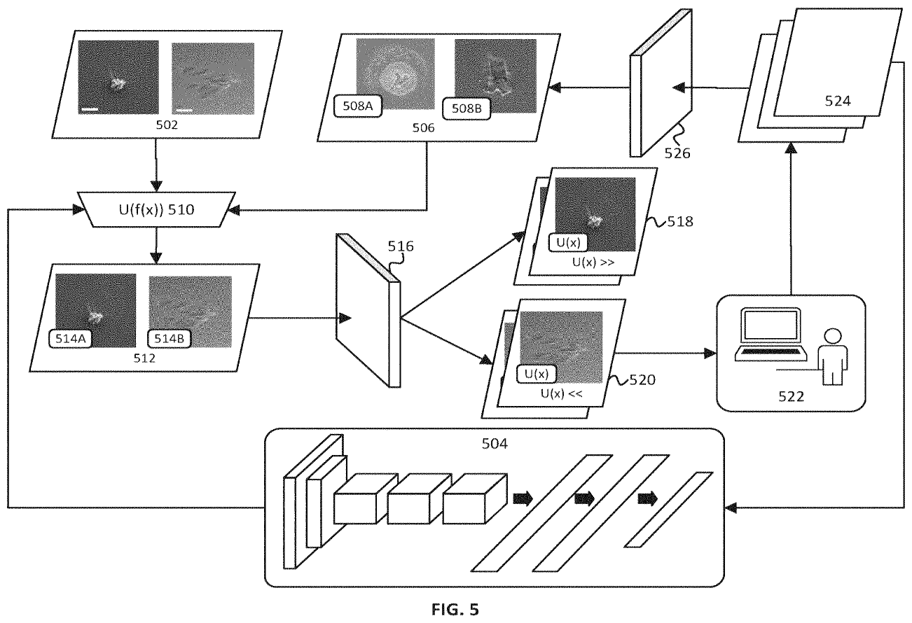

FIG. 5 depicts a schematic overview of a method of training a machine learning model to classify defect images with utility-function-based active learning. A set of unlabeled images 502, which can be the same as or a subset of the images 428A-428C, are obtained. The unlabeled images 502 can be contained in a pool of unlabeled data. The unlabeled images 502 can be backside defect images. The unlabeled images 502 can be SEM images. The unlabeled images 502 are assigned a value based on a utility function 510. The unlabeled images 502 can be each assigned a value based on the utility function 510, for example in batch processing, or one or more of the unlabeled images 502, but less than the entire set, can be assigned a value based on the utility function 510. The utility function 510 can be based on a machine learning model 504 and/or on a set of labeled images 506 (including one or more image labeled with classifications 508A-508B). A utility function value can be determined for one or more of the unlabeled images 502 by classifying the unlabeled images 502 with the machine learning model 504, where the utility function value can be based on one or more outputs of the machine learning model 504 such as a classification, a classification probability, etc. The utility function value can be determined for one or more of the unlabeled images 502 by comparing the one or more of the unlabeled images 502 to the images of the set of labeled images 506. The comparison can be based on a distribution of the set of labeled images 506, including a class representation distribution, a multivariate distribution, etc.

The set of labeled images 506 can comprise images selected from a set of training data 524 used to train the machine learning model 504. The set of labeled images 506 can be selected from the set of training data 524 by one or more optional filtering processes 526 or can comprise the set of training data 524. The training data 524 can comprise a pool of labeled data. The filtering processes can select images from the set of training data based on one or more features-such as class, class representation, quality, etc. For example, if the training data 524 comprises at least one underrepresented class, the one or more optional filtering processes 526 can balance the class representation of the set of labeled images 506.

The unlabeled images 502 and the labeled images 506 can be measurement images, wherein a “measurement image” is an image acquired during measurement (i.e., of a semiconductor fabrication parameter or element) or for use in measurement (i.e., for use in defect density measurement, critical dimension measurement, etc.). A measurement image can be an appropriate image acquired during fabrication upon which measurements can be based, including incidental or non-obvious measurements or measurements determined after the fact. “Measurement image” is not to be taken as limiting on the type of image in any of the embodiments herein.

The machine learning model 504 can be any appropriate machine learning model. The machine learning model 504 can use a weighted loss function to account for class imbalance. A weighted loss function is a function which determines a weight based on error probability and classification. For example, underrepresented classes (where underrepresentation can be a function of class imbalance and/or sampling imbalance) can be weighted more heavily even at low probabilities such that the machine learning model 504 is trained to correct more for errors in classification of the underrepresented classes. The machine learning model 504 can account for or include data augmentation, where data augmentation can include image adjustment such as image rotation, horizontal flipping of images, zooming, translation, and other spatial adjustments. The machine learning model 504 can have a multi-dimensional output layer wherein the number of dimensionalities of the output layer corresponds to the number of classification outputs of the model. For example, for backside defect classification with four classification types (i.e., damage, droplet, particle, and nuisance) the output can be a four-dimensional vector indicating the probability of each type of classification (for example (0.98, 0.02, 0.01, 0.01)). More or fewer dimensions can be present in the output, based on the total number of classifications present in the training data 524. Alternatively, the machine learning model 504 can have greater or fewer outputs, such as subclassifications or even word strings (for example, (damage, 98%, imprint-induced damage 70%, physical shock damage 20%)). The machine learning model 504 can include one or more fully connected layer (e.g., a fully connected hidden layer), where each input to the fully connected layer is connected to each node or function in the fully connected layer, and one or more dropout layer, where a dropout layer can regularly or randomly drop input into one or more of the dropout layers which can be used to reduce overfitting and reduce reliance of layers on each other thereby increasing robustness.

The utility function 510 assigns one or more utility function values to the unlabeled images 502. The utility function 510 can be based on the machine learning model 504. In some embodiments, the unlabeled images 502 can be fed into the machine learning model 504 and classified. If the machine learning model output includes a probability value, the utility function value can be determined based on the probability value for the classification. The probability value can instead or additionally be a confidence value (including a confidence interval), an error value, or any other appropriate measure of probability or confidence in the output of the machine learning model. Alternatively or in addition, the utility function value can be determined based on uncertainty sampling, including entropy uncertainty sampling, least confidence uncertainty sampling, simple margin uncertainty sampling, etc., all referred to herein as “uncertainty sampling.” The utility function 510 can also (alternatively or in addition) be based on the decision nodes of the machine learning model 504. The machine learning model 504 can generate a multi-dimensional space, such as in a k-nearest neighbor mode, where each of the set of training data and classified images are plotted or otherwise situated as a function of multiple variables.

The utility function value can be based on a distance between the unlabeled images 502 and the boundaries of one or more decision node of the machine learning model 504. The utility function 510 can be determined based on the set of training data 524 or a set of labeled images 506, where the set of labeled images 506 can be a subset of the set of training data 524. The utility function 510 can compare features of the unlabeled images 502 to features of the labeled images 506 in one or more dimensions to determine the utility function value. The utility function value can also (alternatively or in addition) be based on a difference between the unlabeled images 502 and one or more of the labeled images 506. Alternatively or in addition, the utility function value can be based on a difference between a distribution of the unlabeled images 502 and a distribution of one or more of the labeled images 506. As discussed in more detail below, the utility function value can be based (alternatively or in addition) on one or more multivariate distance-to-center comparison, density sampling, minimum-maximum sampling, representative sampling, class representation, etc. A distance-to-center comparison can be achieved by selecting points with the greatest average distance from other points in the set of labeled images 506 and/or the set of unlabeled images 502. A minimum-maximum sampling can be achieved by selecting points with the largest minimum distance to other points in the set of labeled images 506 and/or the set of unlabeled images 502. The selection of points can further comprise measuring a distribution of points corresponding to images in a multidimensional space. The distance can be a vector and can have arbitrary units. Sampling can be achieved by selecting images from the set of unlabeled images 502 that are not present or are unrepresented in the set of training data 524. Sampling can also be achieved by selecting images from the set of unlabeled images 502 which match the distribution of images within the set of labeled images 506. Distance between points can determined based on multiple variables, such as outputs from one or more nodes in a hidden layer of the machine learning model, or as a function of multiple dimensions, including dimensions based on the machine learning model (i.e., values at one or more nodes in one or more layers of the machine learning model).

The set of unlabeled images 502 together with their utility function values, as assigned by the utility function 510, become a set of utility-function-valued images 512. Each of the set of utility-function-valued images 512 comprises an image and its utility function value 514A-B which is an image labeled or otherwise tagged with its utility function value. The set of utility-function-valued images 512 can then be filtered and/or ranked by one or more filtering process 516, which can be the same or different as the one or more filtering process 516. The one or more filtering process 516 can include class representation filtering. The one or more filtering process 516 can also be a querying process, such that images are selected from the set of utility-function-valued images 512 one at a time or in a batch. The images are then grouped by utility function value into a set of high utility function value images 518 and a set of low utility function value images 520. The once the images have been sorted into the set of high utility function value images 518 and the set of low utility function value images 520, the utility function value assigned to each image can be retained or discarded. The images can be sorted into the set of high utility function value images 518 and the set of low utility function value images 520 by ranking. As one non-limiting example, the images corresponding to the twenty lowest utility values can comprise the set of low utility function value images 520, where all other images comprise the set of high utility function value images 518. Alternatively, the images can be sorted into the set of the set of high utility function value images 518 and the set of low utility function value images 520 based on a threshold. The threshold can be a numeric image value, a time value (where a time value can correspond to the amount of time available for manual or machine-learning-based classification, a threshold utility function value, etc. For example, the threshold can be such that an image with a utility function less than 0.3 is assigned to the set of low utility function value images 520, where the utility function value is determined based on uncertainty sampling and ranges between zero and one.

The images of the set of low utility function value images 520 are output for auxiliary classification 522. The auxiliary classification 522 may constitute manual classification by a user or teacher, such as an operator knowledgeable in the field of defect identification and/or backside defect identification (i.e., a human expert). The auxiliary classification 522 can also comprise a second machine learning model-either classification by the second machine learning model alone or classification by a user or teacher based on output of the second machine learning model. For example, the second machine learning model can be a machine learning model trained to identify only one type of defect image classification, such as to classify a defect image as corresponding to a particle or not corresponding to a particle. In such an example, defect images classified as not corresponding to a particle can be further classified manually by an operator. The second machine learning model can be a time or resource intensive model which is less suitable for classification of the set of unlabeled images 502 due to time, operating cost, operating power, etc. constrains. In some embodiments, the auxiliary classification 522 can comprise classification by the machine learning model 504 in addition to manual classification and/or one or more other methods or models of classification (i.e., classification by an ensemble of machine learning models which includes the machine learning model 504).

The images classified via the auxiliary classification 522 are then added to the training data 524. The training data 524 can include a set of initial training data, used to train a first iteration of the machine learning model 504, as well as images classified by the auxiliary classification 522 by the current or previous iterations of the machine learning model 504. The training data 524 is then used to train an additional iteration of the machine learning model 504. The additional iteration of the machine learning model 504 can comprise an updated and/or retrained iteration of the machine learning model 504. The additional iteration of the machine learning model 504 can instead comprise new or naïve machine learning model trained based on the training data 524. Iterations of the machine learning model 504 can be checked against one or more training criterion, which can include a testing criterion and/or a stopping criterion.

In another example of the thresholds referred to above, the threshold can be based on an average auxiliary classification time or rate. In a specific, non-limiting example, two images are selected for each available minutes of auxiliary classification 522 time if the operator classified has an average image classification of thirty seconds. The auxiliary classification 522 may be limited by the amount of time a user, operation, or other teacher classifier has available to manually review images. The threshold can be determined by the average classification time, average classification rate, and/or the time available per image or per batch, as just one example.

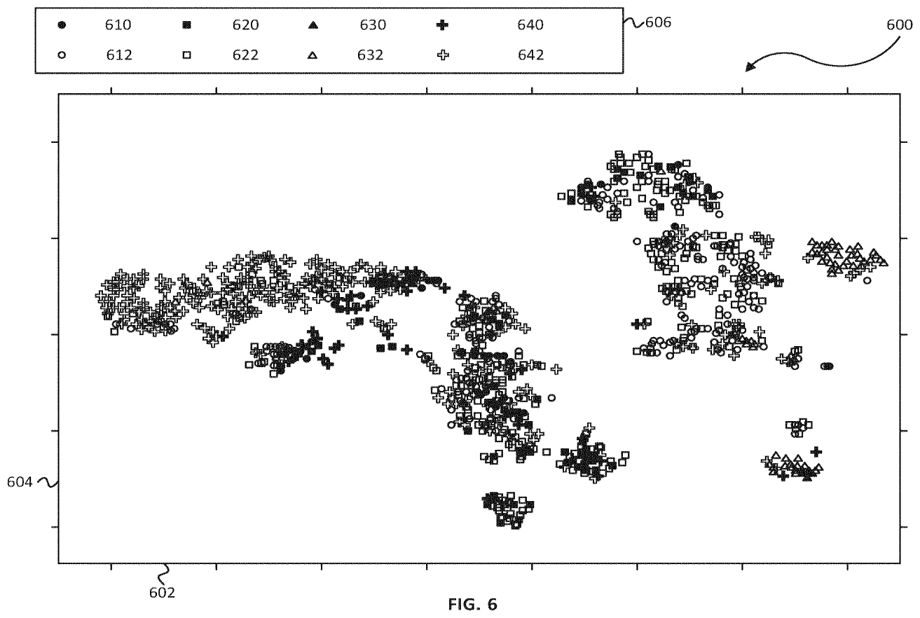

FIG. 6 depicts a visualization of selection of defect images for active learning based on a utility function using representative sampling. A graph 600 depicts images in a two-dimensional space bounded by the x-axis 602 corresponding a first component and the y-axis 604 corresponding to a second component. The two-dimensional depiction is an example only, as images features are multi-dimensional and the x-axis 602 and y-axis 604 correspond to components of reduced dimensionality of the image. For example, each of the defect images can be depicted based on a x-value corresponding to an average value at a first layer of the machine learning model, and a y-value corresponding to an average value at a second layer of the machine learning model. In another example, each of the defect images can be depicted based on two or more parameters, such as where the x-value corresponds to an average pixel value or a maximum contrast between adjacent pixels. Two-dimensional representation is generated using a t-distributed stochastic neighbor embedding (t-SNE) for visualization and does not represent the true dimensionality of the images. The graph 600 contains points which correspond to defect images corresponding to multiple instances of each of the four defect classifications (i.e., damage, droplet, particle, and nuisance) of the example model. A relationship between those points corresponding to defect images selected for auxiliary classification (which are depicted as filled objects) and defect images not selected for auxiliary classification by representative sampling is depicted (which are depicted as empty objects). The images which are not selected for auxiliary classification are not classified by the auxiliary classification and are not added to the training data set. By selecting preferentially selecting the most informative images for auxiliary classification, training time can be decreased and use of expensive auxiliary classification time minimized.

A legend 606 identifies various symbols corresponding to images plotted in the graph 600. Filled circles 610 represent backside defect images corresponding to damage which are selected by representative sampling. Empty circles 612 represent backside defect images corresponding to damage which are not selected by representative sampling. Filled squares 620 represent particle-based backside defect images which are selected by representative sampling. Empty squares 622 represent particle-based backside defect images which are not selected by representative sampling. Filled triangles 630 represent nuisance backside defect images which are selected by representative sampling. Empty triangles 632 represent nuisance backside defect images which are not selected by representative sampling. Filled crosses 640 represent droplet and/or stain backside defect images which are selected by representative sampling. Empty crosses 642 represent droplet and/or stain backside defect images which are not selected by representative sampling. The defect images which are selected by representative sampling are output for auxiliary classification. The defect images which are not selected by representative sampling are discarded or can remain in a pool of unlabeled data for use with a subsequent iteration of training of the machine learning model. The representative samples were chosen by a utility function which determined representative sampling based on a distance-to-center model. In such a model, the utility function assigns low values to points (or images) which are most unlike the data already in the training set. The graph 600 displays selected images (i.e., the filled circles 610, the filled squares 620, the filled triangles 630, and the filled crosses 640) which occur across major groupings of images in the two-dimensional visualization and which are spread over the two-dimensional space.

The distance to center can be determined using any appropriate equation, such as Equation 1 below:

$$x = arg {min}_{x ∈ U} \frac{1}{1 + dist ( x , mean ( {x}_{L} )} \qquad ( 1 )$$

where x is an element of unlabeled data U (i.e., x∈U) and x corresponds to the argument of the minimum (i.e., argmin) of 1/1+dist where dist is the distance between x and the mean of x_{L} and where x_{L} is the set of labeled data.

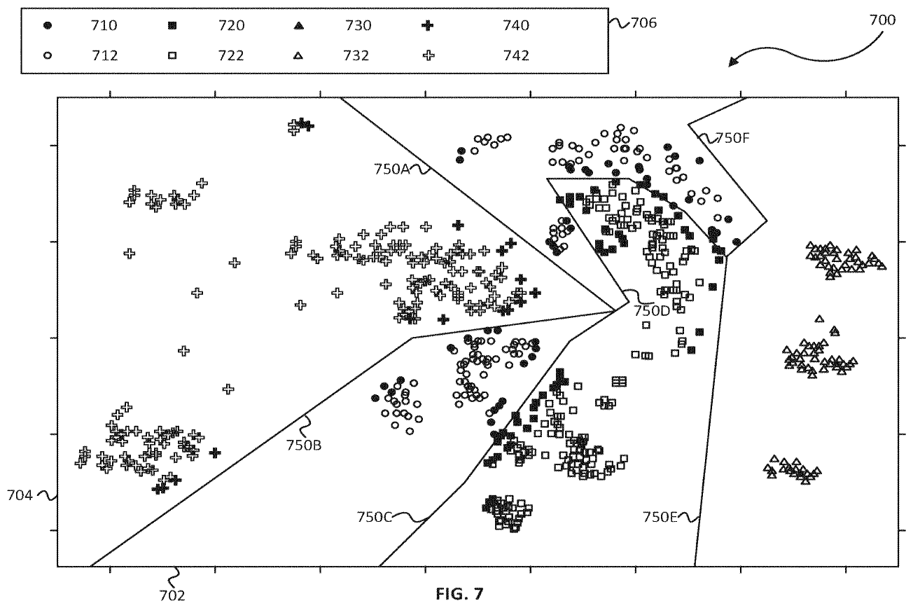

FIG. 7 depicts a visualization of selection of defect images for active learning based on a utility function using decision-node-based sampling. A graph 700 depicts images in a two-dimensional visualization based on t-SNE bounded by x-axis 702 corresponding a first component and y-axis 704 corresponding to a second component. The graph 700 contains points corresponding to each of the four defect classifications of the example model, and a relationship between those points corresponding to images selected for auxiliary classification and images not selected for auxiliary classification by representative sampling is depicted. A legend 706 identifies various symbols corresponding to images plotted in the graph 700: filled circles 710 represent damage-related backside defect images selected based on distance to decision nodes, empty circles 712 represent damage-related backside defect images not selected based on distance to decision nodes, filled squares 720 represent particle-based backside defect images selected based on distance to decision nodes, empty squares 722 represent particle-based backside defect images not selected based on distance to decision nodes, filled triangles 730 represent nuisance backside defect images selected based on distance to decision nodes, empty triangles 732 represent nuisance backside defect images not selected based on distance to decision nodes, filled crosses 740 represent droplet and/or stain backside defect images selected based on distance to decision nodes, and empty crosses 742 represent droplet and/or stain backside defect images not selected based on distance to decision nodes. The decision-node-based sampling images were chosen by a utility function based on a distance to node boundary model. The node boundaries are represented by lines 750A-750F which delineate boundaries between various classifications. The visualization of FIG. 7 is exemplary only, and separation of classes into discrete boundaries depends on the dimensionality of the solution and the variables chosen for plotting. For example, if the x-value corresponds to a pixel value range (i.e., maximum pixel value minus minimum pixel value) and the y-value corresponds to a number of discrete objects detected in the image, it would be expected that the multiple classifications could exist at the same pixel value range. I.e., image contrast by itself is not definitive for classification. If a layer of the machine learning model corresponds to identification of how many objects are detected in the defect image, then classifications may be non-overlapping. For example, defect images displaying damage can correspond to multiple objects, while defect images displaying particles can correspond to a single object. It would be expected that the classifications would be interspersed in space for most but not all reductions in dimensionality. However, if the defect images having A dimensions and are plotted in an A-dimensional space, classifications would be separated by boundaries instead of interspersed.

The decision-node-based samples were chosen by a utility function which determined sampling based on a distance-to-node boundary model. In such a model, the utility function assigns low values to points (or images) which are closes to the boundaries between classifications. The graph 700 displays selected images (i.e., the circles filled 710, the filled squares 720, the filled triangles 730, and the filled crosses 740) which occur to closer to the boundaries between classifications than unselected images (i.e., the empty circles 712, the empty squares 722, the empty triangles 732, and the empty crosses 742).

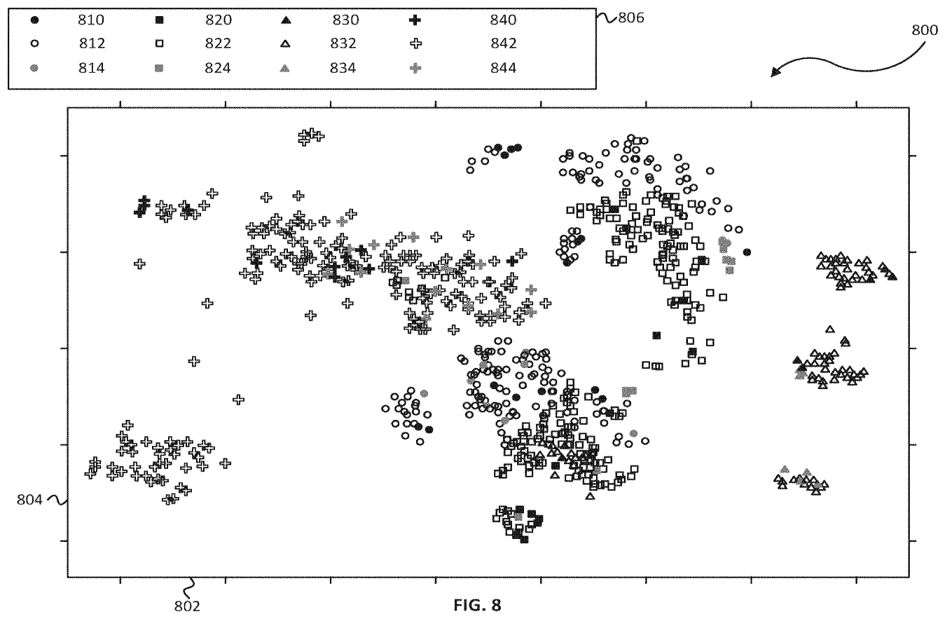

FIG. 8 depicts a visualization of a selection of defect images for active learning based on a utility function using uncertainty sampling. A graph 800 depicts images in a two-dimensional visualization based on t-SNE bounded by x-axis 802 corresponding a first component and y-axis 804 corresponding to a second component. The graph 800 contains points corresponding to each of the four defect classifications of the example model, and a relationship between those points corresponding to images selected for auxiliary classification and images not selected for auxiliary classification by representative sampling is depicted. A legend 806 identifies various symbols corresponding to images plotted in the graph 800.

Dark-filled circles 810 represent damage-related backside defect images with low probability values selected based on uncertainty sampling, empty circles 812 represent damage-related backside defect images with high probability values not selected based on uncertainty sampling, and gray-filled circles 814 represent damage-related backside defect images with medium probability values. The gray-filled circles 814 can represent images which are not currently selected, but can be selected for auxiliary classification based on ranking of images and/or setting of a threshold value for auxiliary classification. Probabilities can range between zero and one, between negative one and one, etc. and will depend on the type of machine learning model selected and the output is it trained to generate. The threshold value can be a probability value. The threshold value can alternatively be an appropriate numerical value for the utility function—i.e., with the same units and/or range as the utility function which may or may not be a probability. For example, the threshold value can be a numerical value between zero and one, between negative one and one, between zero and one hundred, etc. based on the possible values of a specific utility function. The threshold value can be determined based on the determined utility function values. For example, if the utility function values are not probability values (e.g., include class representation values or other non-probabilistic value), then the threshold value can be other than a probability value. The threshold value can be determined based on a ranking and/or ordering of the utility function values. For example, the threshold value can be determined such that a set number of images are selected for auxiliary classification. The set number of images can be determined based on a time available for auxiliary classification and/or a rate of auxiliary classification (such as an average rate for auxiliary classification, an average time for auxiliary classification per image, etc.).

Dark-filled squares 820 represent particle-based backside defect images selected based on uncertainty sampling, empty squares 822 represent particle-based backside defect images not selected based on uncertainty sampling, and gray-filled squares 824 represented particle-based backside defect images with medium probability values. Dark-filled triangles 830 represent nuisance backside defect images selected based on uncertainty sampling, empty triangles 832 represent nuisance backside defect images not selected based on uncertainty sampling, and gray-filled triangles 834 represent nuisance backside defect images with medium probability values. Dark-filled crosses 840 represent droplet and/or stain backside defect images selected based on uncertainty sampling, empty crosses 842 represent droplet and/or stain backside defect images not selected based on uncertainty sampling, and gray-filled crosses 844 represent droplet and/or stain backside defect images with medium probability values.

Uncertainty sampling selects images based on one or more probabilities of classification, which can include one or more probability output by the current iteration of the machine learning model. The utility function value can be one or more probability values, an average, a mean, a weighted average, sum, etc. of one or more probability value, and can optionally be normalized.

The graph 800 displays selected images (i.e., the dark-filled circles 810, the dark-filled squares 820, the dark-filled triangles 830, and the dark-filled crosses 840) which have low probability values—i.e., which are not well classified by the current iteration of the machine learning model—and unselected images (i.e., the empty circles 812, the empty squares 822, the empty triangles 832, and the empty crosses 842). In this example graph, for illustration purposes, a set of images (i.e., the gray-filled circles 814, the gray-filled squares 824, the gray-filled triangles 834, and the gray-filled crosses 844) which have medium probability values are also depicted. As explained above, these images can be included within the selection images for auxiliary classification based on time and/or user limitations.

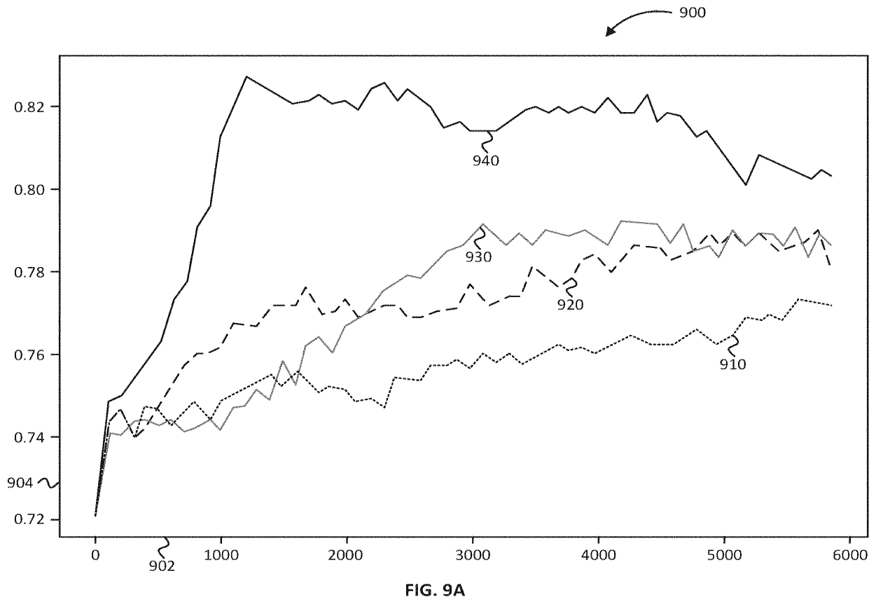

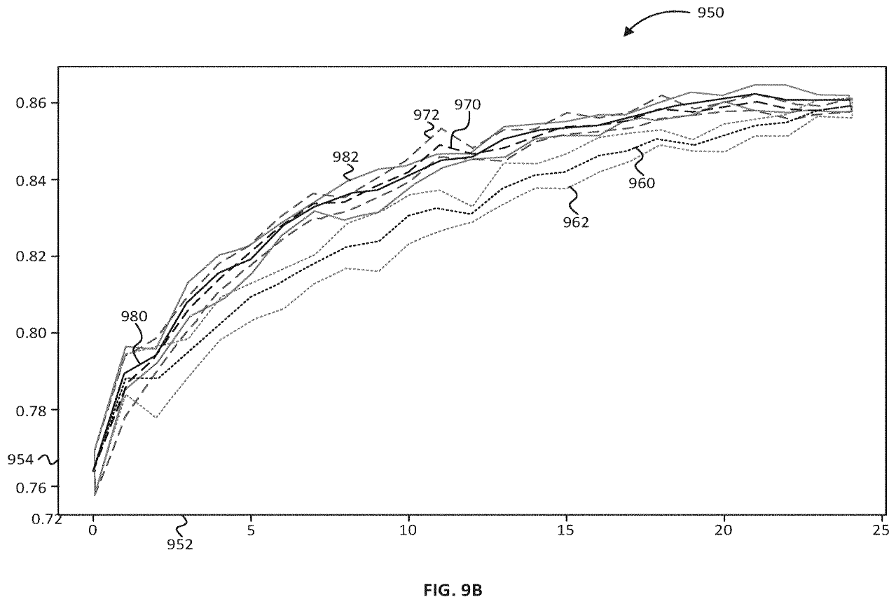

FIG. 9A is a chart depicting example learning speeds for machine learning with various types of utility functions. FIG. 9A is a chart 900 depicting test accuracy for a trained machine learning model as a function of added training samples—for example, images classified by auxiliary classification and added to the training set for an iteratively trained machine learning model. Test accuracy for the machine learning model based on a test set is plotted along y-axis 904 as a function of a number of images added to the training set along the x-axis 902. Various methods of training are represented. A passive learning model is represented by trace 910. In a passive learning model, additional labeled images are added to the training set, but the utility of the additional images is not a factor in their selection. A least confidence utility function is represented by trace 920. A maximum entropy (“max entropy”) utility function is represented by trace 930. A representative utility function is represented by trace 940. As compared to passive learning, the depicted methods of active learning generate higher test accuracy with fewer samples. Utility-function-based active learning can therefore improve defect identification versus other machine learning models. Test accuracy is a non-limiting method of determining model performance. Model performance can also be measured based on accuracy, precision, recall, F score (where the F score is a value determined by an F test or other statistical analysis of classification), F1 score (where the F1 score is the harmonic mean of precision and recall), or any other appropriate metric for success. Model performance can be measured based on one or more test, one or more test data set, and/or one or more metric. Model performance can be measured based on a user defined parameter.

FIG. 9B is a chart depicting example learning speeds for machine learning with various types of utility functions. FIG. 9B is a chart 950 depicting test accuracy for a machine learning model as a function of model iterations for various types of utility functions. Test accuracy for the machine learning model based on a number of model updates or iterations is plotted along y-axis 954 as a function of a number model updates along the x-axis 952. Various types are utility function are represented. A specific passive learning model is represented by trace 960, where test accuracy for multiple passive learning models is represented by an area outlined by a dashed line 962. For the passive learning models, a utility function is not used to select images for auxiliary classification. A specific model using uncertainty sampling is represented by trace 970, where test accuracy for multiple models with uncertainty-sampling-based utility functions are represented by an area outlined by dashed line 972. A specific model using representative sampling is represented by trace 980, where test accuracy for multiple models with representative-sampling-based utility functions are represented by an area outlined by a solid line 982. As compared to passive learning, the depicted methods of active learning (i.e., uncertainty-sampling-based utility function active learning and representative-sampling-based utility function active learning) generate higher test accuracy for the same number of model iterations or updates. Additionally, in active learning models can be updated based on smaller amount of data because the training data which is classified using auxiliary classification is selected for usefulness or utility. Utility-function-based active learning can therefore improve defect identification versus other machine learning models. Test accuracy is a non-limiting method of determining model performance, where model performance can be measured based on any appropriate metric as previously described.

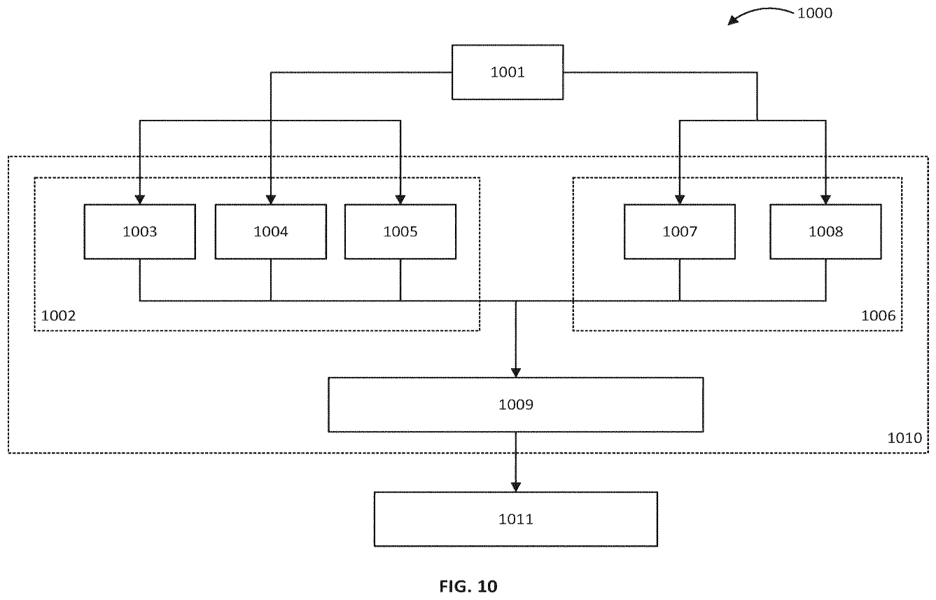

FIG. 10 illustrates an exemplary method 1000 for applying a utility function to an unlabeled image, according to an embodiment. Each of these operations is described in detail below. The operations of method 1000 presented below are intended to be illustrative. In some embodiments, method 1000 may be accomplished with one or more additional operations not described, and/or without one or more of the operations discussed. Additionally, the order in which the operations of method 1000 are illustrated in FIG. 10 and described below is not intended to be limiting. In some embodiments, one or more portions of method 1000 may be implemented (e.g., by simulation, modeling, etc.) in one or more processing devices (e.g., one or more processors). The one or more processing devices may include one or more devices executing some or all of the operations of method 1000 in response to instructions stored electronically on an electronic storage medium. The one or more processing devices may include one or more devices configured through hardware, firmware, and/or software to be specifically designed for execution of one or more of the operations of method 1000, for example.

At an operation 1001, unlabeled images are obtained. The unlabeled images can be SEM images or optical images. The unlabeled images can be backside defect images. The images can be obtained from a measurement device, from other software, or from one or more data storage devices.

At an operation 1002, the unlabeled images are assigned a utility function value based on a machine learning model. The machine learning model can be a current iteration of a trained machine learning model which is trained to classify images. The operation 1002 can comprise one or constituent operations. At an operation 1003, a utility function value is determined based on uncertainty sampling. Uncertainty sampling can be performed based on one or more certainty value, probability value, confidence value, etc. corresponding to the unlabeled images. The unlabeled images can be classified by the machine learning model, where the machine learning model outputs one or more probability along with at least one classification. At an operation 1004, a utility function value is determined based on decision boundary sampling. Decision boundary sampling can be performed based on behavior of nodes of the machine learning model. The unlabeled images can be classified by the machine learning model, and their distance to a decision node determined based on the classification. At an operation 1005, any other appropriate method can be used to determine a utility function value based on the machine learning model. For example, a utility function value can be determined based on classification, where rare classifications can have lower utility value (i.e., be more likely to be selected for auxiliary classifications) than common classifications.

At operation 1006, the unlabeled images are assigned a utility function value based on a training data corresponding to the machine learning model. The training data can be the training data used to generate a current iteration of the machine learning model which is trained to classify images. The operation 1006 can comprise one or constituent operations. At an operation 1007, a utility function value is determined based on representative sampling. Representative sampling can be performed based on one or more method of comparing an image of the unlabeled images or a distribution of the unlabeled images to the set of training data. Representative sampling can include least confident, entropy, distance to center, etc. At an operation 1008, any other appropriate method can be used to determine a utility function value based on the training data of the machine learning model. For example, a utility function value can be determined based on class representation. Multiple types of representative sampling can also be used.

At an operation 1009, a value for the utility function is determined based on one or more subcomponents of the utility function. In some cases, one or more subcomponent of the utility function can be omitted, or can be calculated but omitted from the total utility function value. One or more value of the operations 1002-808 can be summed, average, or otherwise combined to generate a utility function value for each of the unlabeled images obtained. The values output by the operation 1002-1008 can be normalized before combination and/or otherwise weighted to generate a total utility function value. The operations 1003-1009 comprise an operation 1010, an application of the utility function to the obtained unlabeled images.

At an operation 1011, the obtained unlabeled images can be ranked, batched, or otherwise ordered based on the utility function and/or their utility function values.

As described above, method 1000 (and/or the other methods and systems described herein) is configured to provide a generic framework to generate a utility function based on a machine learning model and/or training data of the machine learning model.

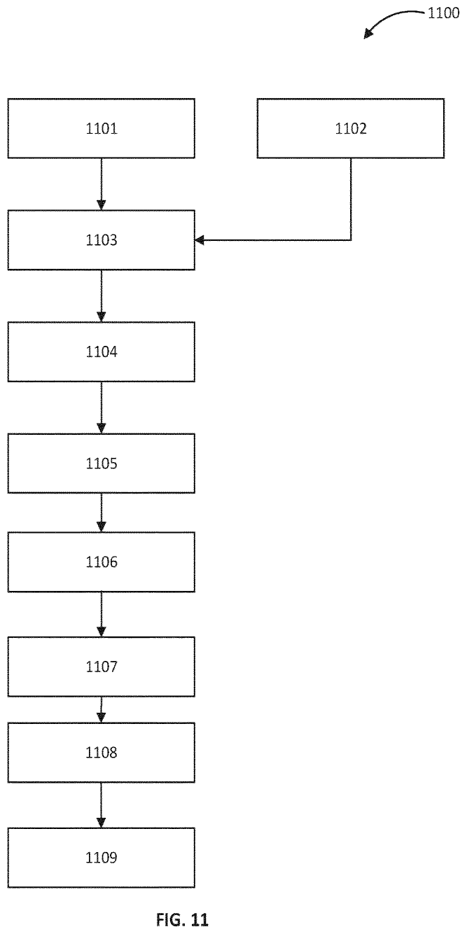

FIG. 11 illustrates an exemplary method 1100 for training a machine learning model with active learning for a utility function based on machine learning classification, according to an embodiment. Each of these operations is described in detail below. The operations of method 1100 presented below are intended to be illustrative. In some embodiments, method 1100 may be accomplished with one or more additional operations not described, and/or without one or more of the operations discussed. Additionally, the order in which the operations of method 1100 are illustrated in FIG. 11 and described below is not intended to be limiting. In some embodiments, one or more portions of method 1100 may be implemented (e.g., by simulation, modeling, etc.) in one or more processing devices (e.g., one or more processors). The one or more processing devices may include one or more devices executing some or all of the operations of method 1100 in response to instructions stored electronically on an electronic storage medium. The one or more processing devices may include one or more devices configured through hardware, firmware, and/or software to be specifically designed for execution of one or more of the operations of method 1100, for example.

At an operation 1101, unlabeled images are obtained. The unlabeled images can be SEM images or optical images. The unlabeled images can be backside defect images. The unlabeled images can be obtained from a measurement device, from other software, or from one or more data storage devices. The unlabeled images can be obtained individual and/or as a batch.

At an operation 1102, a machine learning model N is obtained. The machine learning model N can correspond to the Nth iteration of a machine learning model, the Nth update of the machine learning model, and/or a machine learning model trained on the Nth set of training data. The machine learning model can be any appropriate model. The machine learning model can be a classifier. The machine learning model can output one or more classification for an input image, where the classification can further comprise a classification probability.

At an operation 1103, the unlabeled images obtained at the operation 1101 are classified with the machine learning model N obtained at the operation 1102.

At an operation 1104, a utility function value is determined for the classified images of the operation 1103 based on the classification probability. The utility function value can be the classification probability. Alternatively, the utility function value can be determined based on the classification probability.

At an operation 1105, classified images with low utility function values are selected. The classified images can be selected based on a threshold value of the utility function value and/or based on a ranking of the classified images by utility function value. A set number of classified images can be selected.

At an operation 1106, the selected images are output to auxiliary classification. The auxiliary classification can comprise classification by an operator or teacher. In some embodiments, the auxiliary classification can operate upon the machine learning classification determined in the operation 1103. The auxiliary classification can further comprise a probability value, or alternatively the auxiliary classification can be taken to have a probability of 100% or 1. Outputting the images for auxiliary classification can comprise displaying the images and/or transmitting the images to one or more operations or programs. The images can be output for auxiliary classification sequentially or in one or more batches.

At an operation 1107, the selected images are received with their auxiliary classification. The auxiliarly classified images can be labeled with a classification. The auxiliarly classified images can be received as classified or sequential, or in batches. At an operation 1108, the auxiliarly classified images are added to training data. The training data can comprise a set of training used to generate the machine learning model N.

At an operation 1109, the machine learning model is trained on the updated set of training data. The machine learning model can be iteratively updated or retrained based on the new training data or the updated set of training data. A new machine learning model, such as a generic machine learning model, can be trained a priori based on the updated set of training data.

As described above, method 1100 (and/or the other methods and systems described herein) is configured to provide a generic framework for training a machine learning model with active learning for a utility function based on machine learning classification.

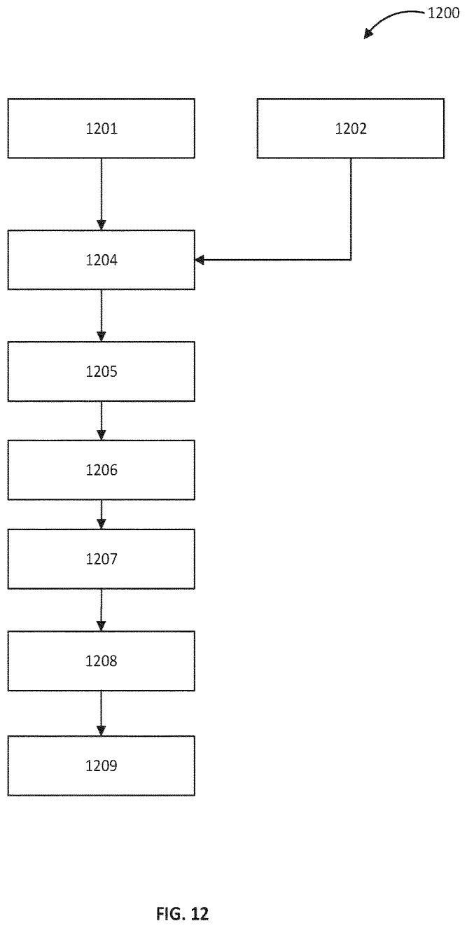

FIG. 12 illustrates an exemplary method 1200 for training a machine learning model with active learning for a utility function based on training data, according to an embodiment. Each of these operations is described in detail below. The operations of method 1200 presented below are intended to be illustrative. In some embodiments, method 1200 may be accomplished with one or more additional operations not described, and/or without one or more of the operations discussed. Additionally, the order in which the operations of method 1200 are illustrated in FIG. 12 and described below is not intended to be limiting. In some embodiments, one or more portions of method 1200 may be implemented (e.g., by simulation, modeling, etc.) in one or more processing devices (e.g., one or more processors). The one or more processing devices may include one or more devices executing some or all of the operations of method 1200 in response to instructions stored electronically on an electronic storage medium. The one or more processing devices may include one or more devices configured through hardware, firmware, and/or software to be specifically designed for execution of one or more of the operations of method 1200, for example.

At an operation 1201, as previously described in reference to the operation 1101 of FIG. 11, unlabeled images are obtained.

At an operation 1202, training data of a machine learning model N is obtained. The machine learning model N can correspond to the Nth iteration of a machine learning model, the Nth update of the machine learning model, and/or a machine learning model trained on the Nth set of training data. The training data can comprise the labeled data used to generate or train the machine learning model. The machine learning model can be any appropriate model and can be trained in any appropriate way. The machine learning model can be a classifier. The machine learning model can output one or more classification for an input image, where the classification can further comprise a classification probability.

At an operation 1204, a utility function value is determined for the unlabeled images obtained at the operation 1102 based on the training data obtained at the operation 1202. The utility function can be determined based on representative sampling, class representation, etc. The utility function can be determined for an unlabeled image or a set of unlabeled images. The utility function can be determined based on a distribution of the unlabeled images in one or more dimension as compared to a distribution of the images within the set of training data, again in one or more dimension.

At an operation 1205, as previously described in reference to the operation 1105 of FIG. 11, classified images with low utility function values are selected.

At an operation 1206, as previously described in reference to the operation 1106 of FIG. 11, the selected images are output to auxiliary classification.

At an operation 1207, as previously described in reference to the operation 1107 of FIG. 11, the selected images are received with their auxiliary classification. At an operation 1208, as previously described in reference to the operation 1108 of FIG. 11, the auxiliarly classified images are added to training data. The training data can comprise a set of training used to generate the machine learning model N.

At an operation 1209, as previously described in reference to the operation 1109 of FIG. 11, the machine learning model is trained on the updated set of training data.

As described above, method 1200 (and/or the other methods and systems described herein) is configured to provide a generic framework for training a machine learning model with active learning for a utility function based on training data.

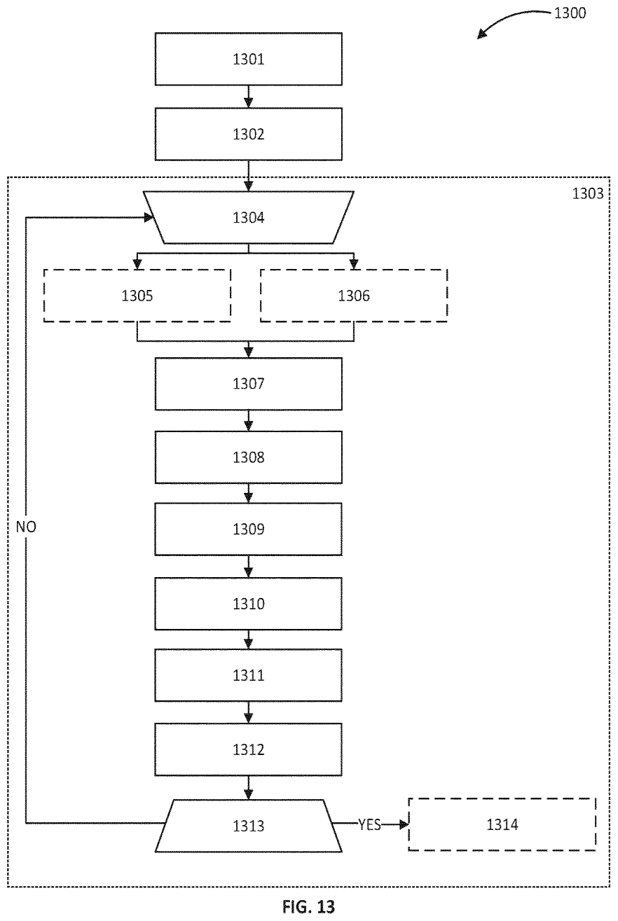

FIG. 13 illustrates an exemplary method 1300 for iteratively training a machine learning model with utility-function-based active learning, according to an embodiment. Each of these operations is described in detail below. The operations of method 1300 presented below are intended to be illustrative. In some embodiments, method 1300 may be accomplished with one or more additional operations not described, and/or without one or more of the operations discussed. Additionally, the order in which the operations of method 1300 are illustrated in FIG. 13 and described below is not intended to be limiting. In some embodiments, one or more portions of method 1300 may be implemented (e.g., by simulation, modeling, etc.) in one or more processing devices (e.g., one or more processors). The one or more processing devices may include one or more devices executing some or all of the operations of method 1300 in response to instructions stored electronically on an electronic storage medium. The one or more processing devices may include one or more devices configured through hardware, firmware, and/or software to be specifically designed for execution of one or more of the operations of method 1300, for example.

At an operation 1301, labeled images for use as training data are obtained. The training data can comprise one or more defect image, including a backside defect image, a classification, one or more probability, etc. The training data can be obtained from a pool of images and can be manually labeled. The training data can comprise a pool of labeled (i.e., classified) images. The labeled images can comprise a set of training data or an initial set of training data. The labeled images can be obtained from a manual labeler, from a program, or from one or more storage device.

At an operation 1302, a machine learning model is trained to classify images based on the training data. The machine learning model can be an appropriate type of model. A first iteration of the machine learning model is trained based on the training set.

Once the machine learning model is initially trained, the machine learning model and/or its training data are used to generate a utility function to select images for active learning (i.e., auxiliary classification). A set of operation 1303 comprise iterative machine learning model training operations.

At an operation 1304, unlabeled images or additional unlabeled are obtained, as previously described in reference to the operation 1101 of FIG. 11.

At an operation 1305, the unlabeled images obtained at the operation 1304 are optionally classified with the current iteration of the machine learning model, as previously described in reference to the operation 1103 of FIG. 11.

At an operation 1306, a utility function value is optionally determined for the unlabeled images based on the training data of the current iteration of the machine learning model, as previously described in reference to operation 1204 of FIG. 12.

At an operation 1307, a total utility function value is determined for the unlabeled images based on the utility function values determined at the operations 1305 and 1306, as optionally including in the operation.

At an operation 1308, classified images with low utility function values are selected, as previously described in reference to the operation 1105 of FIG. 11.

At an operation 1309, the selected images are output to auxiliary classification, as previously described in reference to the operation 1106 of FIG. 11.

At an operation 1310, the selected images are received with their auxiliary classification, as previously described in reference to the operation 1107 of FIG. 11.

At an operation 1311, the auxiliarly classified images are added to the training data or set of training data.

At an operation 1312, the machine learning model is trained on the updated set of training data, as previously described in reference to the operation 1109 of FIG. 11.

At an operation 1313, it is determined if one or more training criterion is satisfied. If the training criterion is satisfied, flow continues to an operation 1314. If the training criterion is not satisfied, flow continues to the operation 1304 where additional unlabeled images are obtained.

At the operation 1314, the trained model is output for defect image classification. The trained model or algorithm can be stored in one or more storage medium and effected by one or more processor. The trained model can classify one or more defect images. The trained model can classify defect images as they are acquired, singly or in batches, or from storage. The trained model can operate on an image measurement device or based on output from an image measurement device. The trained model can operate in or be in communication with one or more process control program. The trained model can include one or more alert, which can be triggered when the trained model detects a certain type or amount of defect classifications.

As described above, method 1300 (and/or the other methods and systems described herein) is configured to provide a generic framework to generate for iteratively training a machine learning model with utility-function-based active learning.

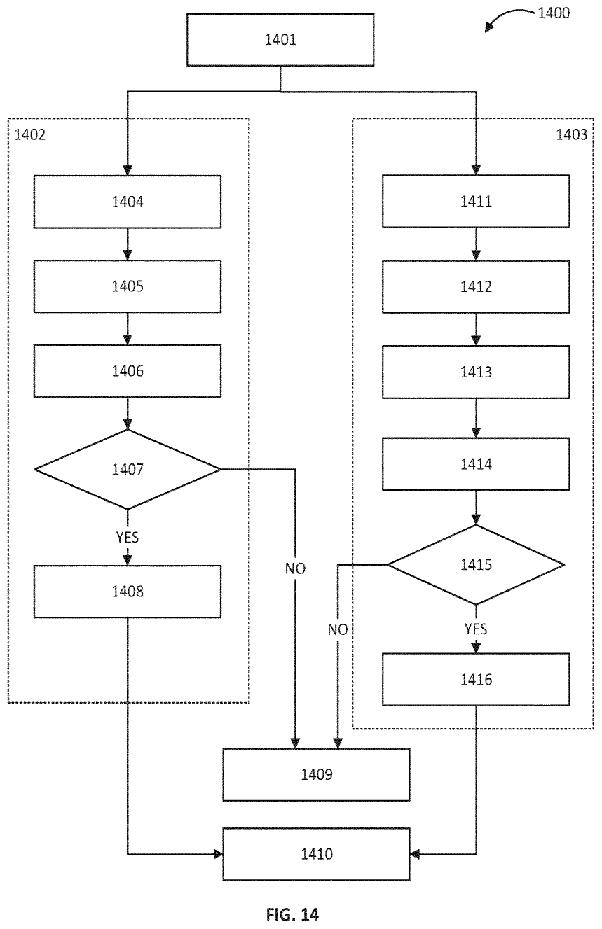

FIG. 14 illustrates an exemplary method 1400 for determining if a training criterion is satisfied, according to an embodiment. Each of these operations is described in detail below. The operations of method 1400 presented below are intended to be illustrative. In some embodiments, method 1400 may be accomplished with one or more additional operations not described, and/or without one or more of the operations discussed. Additionally, the order in which the operations of method 1400 are illustrated in FIG. 14 and described below is not intended to be limiting. In some embodiments, one or more portions of method 1400 may be implemented (e.g., by simulation, modeling, etc.) in one or more processing devices (e.g., one or more processors). The one or more processing devices may include one or more devices executing some or all of the operations of method 1400 in response to instructions stored electronically on an electronic storage medium. The one or more processing devices may include one or more devices configured through hardware, firmware, and/or software to be specifically designed for execution of one or more of the operations of method 1400, for example.

At an operation 1401, a machine learning model N is obtained, as previously described in reference to the operation 1102 of FIG. 11.

The machine learning model N, which is a trained machine learning model, is then tested against a testing criterion at an operation 1402 and/or a stopping criterion at an operation 1403. Both a testing criterion and a stopping criterion are depicted, but it should be understood that either or both criteria can be used as a training criterion, such as that applied at the operation 1313 of FIG. 13.

The operation 1402 for determining a testing criterion comprises operations 1404-1408. At the operation 1404, test data is obtained. The test data can comprise multiple images together with their classifications. The classifications of test data are known. The same test data can be used for multiple machine learning models, including multiple iterations of the same machine learning model. Test data can comprise a small data set, as test data with known classifications can be expensive to produce.

At the operation 1405, the images of the test data are classified with the machine learning model obtained at the operation 1401. The images of the test data can be classified in any appropriate way. The classification can comprise a classification probability.

At the operation 1406, the classifications of the test data as generated by the machine learning model are compared to the known classifications of the test data. The classifications of the test data as generated by the machine learning model can comprise classification probabilities—and the comparison can be a probability comparison and/or a confidence comparison.

At the operation 1407, it is determined if the classifications of the test data as generated by the machine learning model match the known classifications of the test data to within a threshold. The determination can be based on a total number of correct classifications, i.e., an accuracy percentage, a precision, a recall, an F1 score, or any other appropriate metric. The threshold can be a predetermined value, or can be a threshold based on diminishing returns of further training. For example, training can be halted if test accuracy or another performance metric is no longer increasing. If the classifications of the test data as generated by the machine learning model match the known classifications of the test data to within a threshold, flow continues to the operation 1408. If the classifications of the test data as generated by the machine learning model do not match the known classifications of the test data to within a threshold, flow continues to an operation 1409, where additional unlabeled images are obtained and an additional iteration of the machine learning model is trained based on the unlabeled images, as previously described in refence to FIGS. 11-13.

At the operation 1408, it is determined that the testing criterion is satisfied.

At the operation 1410, the trained model is output for image classification, as previously described in reference to the operation 1314 of FIG. 13.

The operation 1403 for determining a stopping criterion comprises operations 1411-1416. At the operation 1411, stopping data is obtained. The stopping data can comprise multiple images without their classifications. The classifications of stopping data are unknown or otherwise not included in the stopping data. The same stopping data can be used for multiple machine learning models, including multiple iterations of the same machine learning model. Stopping data can comprise a larger data set than test data, as stopping data does not require labels and can therefore be obtained more readily.

At the operation 1412, the images of the stopping data are classified with the machine learning model obtained at the operation 1401. The images of the stopping data can be classified in any appropriate way. The classification can comprise a classification probability.

At the operation 1413, a confidence of the classifier (i.e., the machine learning model of the current iteration) is determined. The classifier confidence can be determined based on the classification probabilities of the stopping data, or using any other appropriate method.

At the operation 1414, the confidence of the machine learning model of the current iteration is compared to the confidence of the machine learning model of the previous iteration (i.e., the previous confidence of the classifier). The stopping criterion of the operation 1403 operates to stop training of the model before overtraining reduces the model's performance on a general data set.

At the operation 1415, it is determined if the confidence of the classifier has decreased based on the additional training data used to train the current iteration of the machine learning model versus the previous iteration of the machine learning model. If the confidence has decreased, flow continues to the operation 1416. If the confidence has not decreased, flow continues to the operation 1409, where additional unlabeled images are obtained and an additional iteration of the machine learning model is trained based on the unlabeled images, as previously described in refence to FIGS. 11-13.

At the operation 1416, it is determined that the stopping criterion is satisfied and flow continues to the operation 1410 where the trained machine learning model is output.

As described above, method 1400 (and/or the other methods and systems described herein) is configured to provide a generic framework for determining if a training criterion is satisfied.

A non-transitory computer readable medium may be provided that stores instructions for a processor of a controller (e.g., controller 50 of FIG. 1) to carry out image inspection, image acquisition, activating charged-particle source, adjusting electrical excitation of stigmators, adjusting landing energy of electrons, adjusting objective lens excitation, adjusting secondary electron detector position and orientation, stage motion control, beam separator excitation, applying scan deflection voltages to beam deflectors, receiving and processing data associated with signal information from electron detectors, configuring an electrostatic element, detecting signal electrons, adjusting the control electrode potential, adjusting the voltages applied to the electron source, extractor electrode, and the sample, etc. Common forms of non-transitory media include, for example, a floppy disk, a flexible disk, hard disk, solid state drive, magnetic tape, or any other magnetic data storage medium, a Compact Disc Read Only Memory (CD-ROM), any other optical data storage medium, any physical medium with patterns of holes, a Random Access Memory (RAM), a Programmable Read Only Memory (PROM), and Erasable Programmable Read Only Memory (EPROM), a FLASH-EPROM or any other flash memory, Non-Volatile Random Access Memory (NVRAM), a cache, a register, any other memory chip or cartridge, and networked versions of the same.

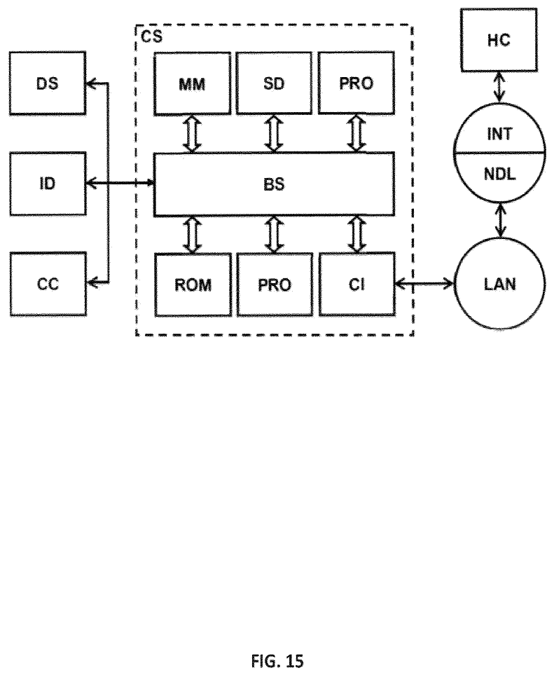

FIG. 15 is a diagram of an example computer system CS that may be used for one or more of the operations described herein. Computer system CS includes a bus BS or other communication mechanism for communicating information, and a processor PRO (or multiple processors) coupled with bus BS for processing information. Computer system CS also includes a main memory MM, such as a random-access memory (RAM) or other dynamic storage device, coupled to bus BS for storing information and instructions to be executed by processor PRO. Main memory MM also may be used for storing temporary variables or other intermediate information during execution of instructions by processor PRO. Computer system CS further includes a read only memory (ROM) ROM or other static storage device coupled to bus BS for storing static information and instructions for processor PRO. A storage device SD, such as a magnetic disk or optical disk, is provided and coupled to bus BS for storing information and instructions.

Computer system CS may be coupled via bus BS to a display DS, such as a cathode ray tube (CRT) or flat panel or touch panel display for displaying information to a computer user. An input device ID, including alphanumeric and other keys, is coupled to bus BS for communicating information and command selections to processor PRO. Another type of user input device is cursor control CC, such as a mouse, a trackball, or cursor direction keys for communicating direction information and command selections to processor PRO and for controlling cursor movement on display DS. This input device typically has two degrees of freedom in two axes, a first axis (e.g., x) and a second axis (e.g., y), that allows the device to specify positions in a plane. A touch panel (screen) display may also be used as an input device.

In some embodiments, portions of one or more methods described herein may be performed by computer system CS in response to processor PRO executing one or more sequences of one or more instructions contained in main memory MM. Such instructions may be read into main memory MM from another computer-readable medium, such as storage device SD. Execution of the sequences of instructions included in main memory MM causes processor PRO to perform the process steps (operations) described herein. One or more processors in a multi-processing arrangement may also be employed to execute the sequences of instructions contained in main memory MM. In some embodiments, hard-wired circuitry may be used in place of or in combination with software instructions. Thus, the description herein is not limited to any specific combination of hardware circuitry and software.

The term “computer-readable medium” and/or “machine readable medium” as used herein refers to any medium that participates in providing instructions to processor PRO for execution. Such a medium may take many forms, including but not limited to, non-volatile media, volatile media, and transmission media. Non-volatile media include, for example, optical or magnetic disks, such as storage device SD. Volatile media include dynamic memory, such as main memory MM. Transmission media include coaxial cables, copper wire and fiber optics, including the wires that comprise bus BS. Transmission media can also take the form of acoustic or light waves, such as those generated during radio frequency (RF) and infrared (IR) data communications. Computer-readable media can be non-transitory, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge. Non-transitory computer readable media can have instructions recorded thereon. The instructions, when executed by a computer, can implement any of the operations described herein. Transitory computer-readable media can include a carrier wave or other propagating electromagnetic signal, for example.

Various forms of computer readable media may be involved in carrying one or more sequences of one or more instructions to processor PRO for execution. For example, the instructions may initially be borne on a magnetic disk of a remote computer. The remote computer can load the instructions into its dynamic memory and send the instructions over a telephone line using a modem. A modem local to computer system CS can receive the data on the telephone line and use an infrared transmitter to convert the data to an infrared signal. An infrared detector coupled to bus BS can receive the data carried in the infrared signal and place the data on bus BS. Bus BS carries the data to main memory MM, from which processor PRO retrieves and executes the instructions. The instructions received by main memory MM may optionally be stored on storage device SD either before or after execution by processor PRO.

Computer system CS may also include a communication interface CI coupled to bus BS. Communication interface CI provides a two-way data communication coupling to a network link NDL that is connected to a local network LAN. For example, communication interface CI may be an integrated services digital network (ISDN) card or a modem to provide a data communication connection to a corresponding type of telephone line. As another example, communication interface CI may be a local area network (LAN) card to provide a data communication connection to a compatible LAN. Wireless links may also be implemented. In any such implementation, communication interface CI sends and receives electrical, electromagnetic, or optical signals that carry digital data streams representing various types of information.

Network link NDL typically provides data communication through one or more networks to other data devices. For example, network link NDL may provide a connection through local network LAN to a host computer HC. This can include data communication services provided through the worldwide packet data communication network, now commonly referred to as the “Internet” INT. Local network LAN (Internet) may use electrical, electromagnetic, or optical signals that carry digital data streams. The signals through the various networks and the signals on network data link NDL and through communication interface CI, which carry the digital data to and from computer system CS, are exemplary forms of carrier waves transporting the information.

Computer system CS can send messages and receive data, including program code, through the network(s), network data link NDL, and communication interface CI. In the Internet example, host computer HC might transmit a requested code for an application program through Internet INT, network data link NDL, local network LAN, and communication interface CI. One such downloaded application may provide all or part of a method described herein, for example. The received code may be executed by processor PRO as it is received, and/or stored in storage device SD, or other non-volatile storage for later execution. In this manner, computer system CS may obtain application code in the form of a carrier wave.

The concepts disclosed herein may simulate or mathematically model any generic imaging, etching, polishing, inspection, etc. system for sub wavelength features, and may be useful with emerging imaging technologies capable of producing increasingly shorter wavelengths. Emerging technologies include EUV (extreme ultraviolet), DUV lithography that is capable of producing a 193 nm wavelength with the use of an ArF laser, and even a 157 nm wavelength with the use of a Fluorine laser. Moreover, EUV lithography is capable of producing wavelengths within a range of 20-50 nm by using a synchrotron or by hitting a material (either solid or a plasma) with high energy electrons in order to produce photons within this range.

While the concepts disclosed herein may be used for manufacturing with a substrate such as a silicon wafer, it shall be understood that the disclosed concepts may be used with any type of manufacturing system (e.g., those used for manufacturing on substrates other than silicon wafers).

Further embodiments according to the invention are described in below numbered clauses:

1. One or more non-transitory, machine-readable medium having instructions thereon, the instructions when executed by a processor being configured to: determine a utility function value for unclassified measurement images based on a machine learning model, wherein the machine learning model is trained using a pool of labeled measurement images; based on a determination that the utility function value for a given unclassified measurement image is less than a threshold value, output the unclassified measurement image for classification without the use of the machine learning model; and add the unclassified measurement images classified via the classification without the use of the machine learning model to the pool of labeled measurement images.
2. The one or more non-transitory, machine-readable medium of clause 1, wherein the determining of the utility function value comprise instructions to: classify the unclassified measurement images with the machine learning model; and determine the utility function value based on the machine learning model classification.
3. The one or more non-transitory, machine-readable medium of clause 2, wherein the machine learning model classification further comprises a classification probability, and wherein the determining of the utility function value comprise instructions to determine the utility function value based on the classification probability.
4. The one or more non-transitory, machine-readable medium of clause 2, wherein the utility function value is determined based on uncertainty sampling.
5. The one or more non-transitory, machine-readable medium of clause 4, wherein the utility function value is based on entropy uncertainty sampling.
6. The one or more non-transitory, machine-readable medium of clause 4, wherein the utility function value is based on least confidence uncertainty sampling.
7. The one or more non-transitory, machine-readable medium of clause 4, wherein the utility function value is based on simple margin uncertainty sampling.
8. The one or more non-transitory, machine-readable medium of clause 2, wherein determining the utility function value comprises identifying those of the unclassified measurement images near decision boundaries of one or more nodes of the machine learning model.
9. The one or more non-transitory, machine-readable medium of clause 1, wherein instructions to determine the utility function value comprise instructions to determine the utility function value based on training data corresponding to the machine learning model.
10. The one or more non-transitory, machine-readable medium of clause 9, wherein the utility function value is determined based on a relationship between the training data corresponding to the machine learning model and the unclassified measurement images.
11. The one or more non-transitory, machine-readable medium of clause 10, wherein the utility function value is determined based on a comparison of a distribution of the training data corresponding to the machine learning model and a distribution of the unclassified measurement images.
12. The one or more non-transitory, machine-readable medium of clause 11, wherein the comparison is a multivariate distance-to-center comparison.
13. The one or more non-transitory, machine-readable medium of clause 11, wherein the comparison is based on density sampling.
14. The one or more non-transitory, machine-readable medium of clause 11, wherein the comparison is based on minimum-maximum sampling.
15. The one or more non-transitory, machine-readable medium of clause 9, wherein the utility function value is determined based on representative sampling.
16. The one or more non-transitory, machine-readable medium of clause 9, wherein the utility function value is determined based on class representation.
17. The one or more non-transitory, machine-readable medium of claim 1, wherein the determining of the utility function value comprises instructions to: classify the unclassified measurement images with the machine learning model, wherein the machine learning model classification further comprises a classification probability; and determine the utility function value based on uncertainty sampling based on classification probability and based on representative sampling based on a relationship between training data corresponding to the machine learning model and the unclassified measurement images.
18. The one or more non-transitory, machine-readable medium of any one of clauses 1 to 17, wherein classification without the machine learning model comprises auxiliary classification.
19. The one or more non-transitory, machine-readable medium of any one of clauses 1 to 18, further comprising determining the threshold value, wherein the threshold value is determined based on a time frame for user classification.
20. The one or more non-transitory, machine-readable medium of any one of clauses 1 to 19, further comprising determining the threshold value, wherein the threshold value is determined based on a quantity of images for user classification.
21. The one or more non-transitory, machine-readable medium of any one of clauses 1 to 20, wherein when the utility function value is less than the threshold value, classification with the machine learning model is conducted in addition to the classification without the machine learning model.
22. The one or more non-transitory, machine-readable medium of any one of clauses 1 to 21, wherein classification without the machine learning model comprises classification based on a second trained machine learning model.
23. The one or more non-transitory, machine-readable medium of any one of clauses 1 to 22, further comprising instructions to: evaluate the machine learning model, wherein evaluating the machine learning model comprises instructions to, classify test measurement images via the machine learning model, wherein the test measurement images also have known classifications; and determine a model performance based on a relationship between the known classifications of the test measurement images and the classifications of the test measurement images classified via the machine learning model.
24. The one or more non-transitory, machine-readable medium of clause 23, wherein instructions to evaluate the machine learning model further comprises instructions to determine at least one of a recall score, a precision score, a harmonic mean of recall and precision, or a combination thereof, and wherein instructions to determine a model performance comprise instructions to determine a model performance based on at least one of the recall score, the precision score, the harmonic mean of the recall and precision, or the combination thereof.
25. The one or more non-transitory, machine-readable medium of clause 23 or 24, further comprising instructions to, based on a determination that the model performance is less than an performance threshold, iteratively train the machine learning model.
26. The one or more non-transitory, machine-readable medium of clause 25, wherein instruction to iteratively train the machine learning model comprise instructions to iteratively update the machine learning model based on additions to the pool of labeled measurement images.
27. The one or more non-transitory, machine-readable medium of clause 25, wherein instruction to iteratively train the machine learning model comprise instruction to: determined the utility function value for additional unclassified measurement images; based on a determination that the utility function value for a given additional unclassified measurement image is less than the threshold value, output the additional unclassified measurement image for the classification without the machine learning model; and add the additional unclassified measurement images classified via the classification without the use of the machine learning model to the pool of labeled measurement images.
28. The one or more non-transitory, machine-readable medium of any one of clauses 1 to 17, further comprising instructions to: estimate a confidence value for the machine learning model based on evaluation measurement images; determine if a stopping criterion is satisfied based on the confidence value; and based on a determination that the stopping criterion is not satisfied, iteratively update the machine learning model based on additions to the pool of labeled measurement images.
29. The one or more non-transitory, machine-readable medium of clause 28, wherein instructions to estimate the confidence value comprise instructions to: classify the evaluation measurement images with the machine learning model, wherein the machine learning model classifications further comprise classification probabilities; and determine the confidence value based on the classification probabilities.
30. The one or more non-transitory, machine-readable medium of clause 28 or 29, wherein the stopping criterion is based on the confidence value of a previous iteration of the machine learning model.
31. The one or more non-transitory, machine-readable medium of clause 30, wherein the stopping criterion is determined based on a difference between the confidence value of the previous iteration of the machine learning model and the confidence value of the trained machine learning model.
32. The one or more non-transitory, machine-readable medium of any one of clauses 28 to 31, wherein the evaluation measurement images do not have known classifications.
33. The one or more non-transitory, machine-readable medium of any one of clauses 1 to 32, further comprising instruction to: train the machine learning model based on the pool of labeled measurement images with addition of the unclassified measurement images classified via the classification without the use of the machine learning model.
34. One or more non-transitory, machine-readable medium having instructions thereon, the instructions when executed by a processor being configured to: obtain a measurement image; and use a machine learning model to classify the measurement image, wherein the machine learning model has been trained using a pool of labeled measurement images, wherein the pool of labeled measurement images comprises measurement images labeled by: determining a utility function value for a set of unclassified measurement images based on the machine learning model; based on a determination that the utility function value for a given unclassified measurement image is less than a threshold value, outputting the unclassified measurement image for classification without the machine learning model; and adding the unclassified measurement images classified via the classification without the use of the machine learning model to the pool of labeled measurement images.
35. The one or more non-transitory, machine-readable medium of clause 34, wherein the measurement image is a scanning electron microscopy (SEM) image.
36. The one or more non-transitory, machine-readable medium of clause 34 or 35, wherein the measurement image is a defect image and wherein the measurement image is classified as at least one of a class of defects.
37. The one or more non-transitory, machine-readable medium of clause 36, wherein the defect image is a backside defect image.
38. The one or more non-transitory, machine-readable medium of clause 37, wherein the class of defects comprises at least one of damage, droplet, particle, nuisance, or a combination thereof.
39. One or more non-transitory, machine-readable medium having instructions thereon, the instructions when executed by a processor being configured to: determine a utility function value for an unclassified measurement image based on a trained machine learning model or on uncertainty sampling, representative sampling, or a combination thereof.
40. The one or more non-transitory, machine-readable medium of clause 39, further wherein the utility function value is determined based on least confidence uncertainty sampling, entropy uncertainty sampling, distance-to-center representative sampling, or a combination thereof.
41. A system comprising: a processor; and one or more non-transitory, machine-readable medium as described in any of clauses 1 to 40.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

In addition, the combination and sub-combinations of disclosed elements may comprise separate embodiments. For example, one or more of the operations described above may be included in separate embodiments, or they may be included together in the same embodiment.

The descriptions above are intended to be illustrative, not limiting. Thus, it will be apparent to one skilled in the art that modifications may be made as described without departing from the scope of the claims set out below.

1. One or more non-transitory, machine-readable mediums having instructions therein or thereon, the instructions, when executed by one or more processors, configured to cause the one or more processors to at least:
determine a utility function value for unclassified measurement images based on a machine learning model, wherein the machine learning model is trained using a pool of labeled measurement images;
based on a determination that the utility function value for a given unclassified measurement image is less than a threshold value, output the given unclassified measurement image for classification without the use of the machine learning model; and
add one or more unclassified measurement images classified via the classification without the use of the machine learning model to the pool of labeled measurement images.

2. The one or more non-transitory, machine-readable mediums of claim 1, wherein the instructions configured to cause the one or more processors to determine the utility function value are further configured to cause the one or more processors to:
classify the unclassified measurement images with the machine learning model; and
determine the utility function value based on the machine learning model classification.

3. The one or more non-transitory, machine-readable mediums of claim 2, wherein the machine learning model classification further comprises a classification probability, and wherein the instructions configured to cause the one or more processors to determine the utility function value are further configured to cause the one or more processors to determine the utility function value based on the classification probability.

4. The one or more non-transitory, machine-readable mediums of claim 2, wherein the utility function value is determined based on uncertainty sampling.

5. The one or more non-transitory, machine-readable mediums of claim 4, wherein the utility function value is based on entropy uncertainty sampling.

6. The one or more non-transitory, machine-readable mediums of claim 4, wherein the utility function value is based on least confidence uncertainty sampling.

7. The one or more non-transitory, machine-readable mediums of claim 4, wherein the utility function value is based on simple margin uncertainty sampling.

8. The one or more non-transitory, machine-readable mediums of claim 2, wherein the instructions configured to cause the one or more processors to determine the utility function value are further configured to cause the one or more processors to identify those of the unclassified measurement images near decision boundaries of one or more nodes of the machine learning model.

9. The one or more non-transitory, machine-readable mediums of claim 1, wherein instructions to determine the utility function value comprise instructions to determine the utility function value based on training data corresponding to the machine learning model.

10. The one or more non-transitory, machine-readable mediums of claim 9, wherein the utility function value is determined based on a relationship between the training data corresponding to the machine learning model and the unclassified measurement images.

11. The one or more non-transitory, machine-readable mediums of claim 10, wherein the utility function value is determined based on a comparison of a distribution of the training data corresponding to the machine learning model and a distribution of the unclassified measurement images.

12. The one or more non-transitory, machine-readable mediums of claim 11, wherein the comparison is a multivariate distance-to-center comparison.

13. The one or more non-transitory, machine-readable mediums of claim 11, wherein the comparison is based on density sampling.

14. The one or more non-transitory, machine-readable mediums of claim 11, wherein the comparison is based on minimum-maximum sampling.

15. One or more non-transitory, machine-readable mediums having instructions therein or thereon, the instructions, when executed by one or more processors, configured to cause the one or more processors to at least:
obtain a measurement image; and
use a machine learning model to classify the measurement image, wherein the machine learning model has been trained using a pool of labeled measurement images, wherein the pool of labeled measurement images comprises measurement images labeled by:
determination of a utility function value for a set of unclassified measurement images based on the machine learning model;
based on a determination that the utility function value for a given unclassified measurement image is less than a threshold value, output of the given unclassified measurement image for classification without the machine learning model; and
addition of the one or more unclassified measurement images classified via the classification without the use of the machine learning model to the pool of labeled measurement images.

16. The one or more non-transitory, machine-readable mediums of claim 15, wherein the measurement image is a scanning electron microscopy (SEM) image.

17. The one or more non-transitory, machine-readable mediums of claim 15, wherein the measurement image is a defect image and wherein the measurement image is classified as at least one class of defect.

18. The one or more non-transitory, machine-readable mediums of claim 17, wherein the defect image is a backside defect image.

19. The one or more non-transitory, machine-readable mediums of claim 17, wherein the at least one class of defect comprises at least one selected from: damage, droplet, particle, nuisance, or a combination selected therefrom.

20. One or more non-transitory, machine-readable mediums having instructions therein or thereon, the instructions, when executed by one or more processors, configured to cause the one or more processors to at least determine a utility function value for an unclassified measurement image based on a trained machine learning model or on uncertainty sampling, representative sampling, or a combination thereof.
